(19) United States
(12) Patent Application Publication
(10) Pub. No.: US 2026/0281327 A1
(43) Pub. Date: Sep. 17, 2026

(54) Methods and Apparatus of Blending Intra Prediction for Video Coding

(71) Applicant: MEDIATEK INC., Hsinchu City (TW)

(72) Inventors: Man-Shu CHIANG, Hsinchu City (TW); Chih-Wei HSU, Hsinchu City (TW); Ching-Yeh CHEN, Hsinchu City (TW)

(21) Appl. No.: 19/168,553

(22) PCT Filed: Apr. 12, 2024
(86) PCT No.: PCT/CN2024/087420

§ 371 Date: Sep. 24, 2025

Related U.S. Application Data
(60) Provisional application No. 63/496,042, filed on Apr. 14, 2023.
(60) Provisional application No. 63/496,044, filed on Apr. 14, 2023.

(51) Int. Cl. H04N 19/11; H04N 19/176

(52) U.S. Cl. CPC H04N 19/11; H04N 19/176

(57) ABSTRACT

A method and apparatus for video coding using Matrix-based Intra Prediction (MIP) mode with various settings. According to the method, a target MIP mode is determined using an MIP mode setting, and the MIP mode setting incorporates blending setting, transposing setting, representative mode setting, inheriting setting, or a combination thereof. The MIP mode setting with the blending setting includes a blended matrix candidate formed by combining two or more hypotheses of predictions. The MIP mode setting with the transposing setting includes a transposed matrix candidate generated by transposing one or more matrix coefficients or one or more reference samples. The MIP mode setting with the representative mode setting includes a representative mode generated according to the representative mode setting. Or, the MIP mode setting with the inheriting setting includes an inherited MIP candidate. The current block is encoded or decoded using the target MIP mode.

### CROSS REFERENCE TO RELATED APPLICATIONS

The present invention is a non-Provisional Application of and claims priority to U.S. Provisional Patent Application No. 63/496,042, filed on Apr. 14, 2023 and U.S. Provisional Patent Application No. 63/496,044, filed on Apr. 14, 2023. The U.S. Provisional Patent Applications are hereby incorporated by reference in their entireties.

### FIELD OF THE INVENTION

The present invention relates to video coding system. In particular, the present invention relates to blending intra matrix prediction mode with various settings to improve the coding performance.

### BACKGROUND

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology-Coded representation of immersive media-Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video encoding system incorporating loop processing. For Intra Prediction 110, the prediction data is derived based on previously coded video data in the current picture. For Inter Prediction 112, Motion Estimation (ME) is performed at the encoder side and Motion Compensation (MC) is performed based on the result of ME to provide prediction data derived from other picture(s) and motion data. Switch 114 selects Intra Prediction 110 or Inter Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, is provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g., ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

### Partitioning of the CTUs Using a Tree Structure

In VVC, the coding tree scheme supports the ability for the luma and chroma to have a separate block tree structure. For P and B slices, the luma and chroma CTBs in one CTU have to share the same coding tree structure. However, for I slices, the luma and chroma can have separate block tree structures. When separate block tree mode is applied, luma CTB is partitioned into CUs by one coding tree structure, and the chroma CTBs are partitioned into chroma CUs by another coding tree structure. This means that a CU in an I slice may consist of a coding block of the luma component or coding blocks of two chroma components, and a CU in a P or B slice always consists of coding blocks of all three colour components unless the video is monochrome.

Intra Mode Coding with 67 Intra Prediction Modes

To capture the arbitrary edge directions presented in natural video, the number of directional intra modes in VVC is extended from 33, as used in HEVC, to 65 and the planar and DC modes remain the same.

In VVC, several conventional angular intra prediction modes are adaptively replaced with wide-angle intra prediction modes for the non-square blocks.

### Intra Mode Coding

To keep the complexity of the most probable mode (MPM) list generation low, an intra mode coding method with 6 MPMs (or called primary MPMs) is used by considering two available neighbouring intra modes. The following three aspects are considered to construct the MPM list:
Default intra modes
Neighbouring intra modes
Derived intra modes

### Decoder-Side Intra Mode Derivation (DIMD)

When DIMD is applied, two intra modes are derived from the reconstructed neighbouring samples (template), and those two predictors are combined with the planar mode predictor with the weights derived from the gradients.

To implicitly derive the intra prediction modes of a block, a texture gradient analysis is performed at both encoder and decoder sides. This process starts with an empty Histogram of Gradient (HoG) with 65 entries, corresponding to the 65 angular modes. Amplitudes of these entries are determined during the texture gradient analysis.

In the first step, DIMD picks a template of T=3 columns and lines from respectively left and above to the current block. This area is used as the reference for the gradient based intra prediction modes derivation.

In the second step, the horizontal and vertical Sobel filters are applied on all 3×3 window positions, centred on the pixels of the middle line of the template. On each window position, Sobel filters calculate the intensity of pure horizontal and vertical directions as Gₓ and G_{y}, respectively. Then, the texture angle of the window is calculated as:

$$angle = arctan ( {G}_{x} / {G}_{y} ) ,$$

which can be converted into one of 65 angular intra prediction modes. Once the intra prediction modes index of current window is derived as idx, the amplitude of its entry in the HoG[idx] is updated by addition of:

$$ampl = \vert {G}_{x} \vert + \vert {G}_{y} \vert$$

FIGS. 2A-C show an example of HoG, calculated after applying the above operations on all pixel positions in the template. FIG. 2A illustrates an example of selected template 220 for a current block 210. Template 220 comprises T lines above the current block and T columns to the left of the current block. For intra prediction of the current block, the area 230 at the above and left of the current block corresponds to a reconstructed area and the area 240 below and at the right of the block corresponds to an unavailable area. FIG. 2B illustrates an example for T=3 and the HoGs are calculated for pixels 260 in the middle line and pixels 262 in the middle column. For example, for pixel 252, a 3×3 window 250 is used. FIG. 2C illustrates an example of the amplitudes (ampl) calculated based on the equation above.

Once HoG is computed, the indices with two tallest histogram bars are selected as the two implicitly derived intra prediction modes for the block and are further combined with the Planar mode as the prediction of DIMD mode. The prediction fusion is applied as a weighted average of the above three predictors. To this aim, the weight of planar is fixed to 21/64 (~1/3). The remaining weight of 43/64 (~2/3) is then shared between the two HoG IPMs, proportionally to the amplitude of their HoG bars.

### Template-Based Intra Mode Derivation (TIMD)

Template-based intra mode derivation (TIMD) mode implicitly derives the intra prediction mode of a CU using a neighbouring template at both the encoder and decoder, instead of signalling the intra prediction mode to the decoder. As shown in FIG. 3, the prediction samples of the template (312 and 314) for the current block 310 are generated using the reference samples (320 and 322) of the template for each candidate mode. A cost is calculated as the SATD (Sum of Absolute Transformed Differences) between the prediction samples and the reconstruction samples of the template. The intra prediction mode with the minimum cost is selected as the TIMD mode (as the mode derivation of DIMD mode) and used for intra prediction of the CU. The candidate modes may be 67 intra prediction modes as in VVC or extended to 131 intra prediction modes. In general, MPMs can provide a clue to indicate the directional information of a CU. Thus, to reduce the intra mode search space and utilize the characteristics of a CU, the intra prediction mode can be implicitly derived from the MPM list.

For each intra prediction mode in MPMs, the SATD (TIMD cost) between the prediction and reconstruction samples of the template is calculated. First two intra prediction modes with the minimum SATD are selected as the TIMD modes. These two TIMD modes are fused with weights after applying PDPC process, and such weighted intra prediction is used to code the current CU. Position dependent intra prediction combination (PDPC) is included in the derivation of the TIMD modes.

The costs of the two selected modes are compared with a threshold, in the test, the cost factor of 2 is applied as follows:

$$costMode 2 < 2 * costMode 1.$$

If this condition is true, the fusion is applied, otherwise only model is used (i.e., single mode case). Weights of the modes are computed from their SATD costs as follows:

$$weight 1 = costMode 2 / ( costMode 1 + costMode 2 )$$

$$weight 2 = 1 - weight 1.$$

### Intra Sub-Partitions (ISP)

The intra sub-partitions (ISP) divides luma intra-predicted blocks vertically or horizontally into 2 or 4 sub-partitions depending on the block size. For each sub-partition, reconstructed samples are obtained by adding the residual signal to the prediction signal. Here, a residual signal is generated by the processes such as entropy decoding, inverse quantization and inverse transform. Therefore, the reconstructed sample values of each sub-partition are available to generate the prediction of the next sub-partition, and each sub-partition is processed repeatedly. In addition, the first sub-partition to be processed is the one containing the top-left sample of the CU and then continuing downwards (horizontal split) or rightwards (vertical split). As a result, reference samples used to generate the sub-partitions prediction signals are only located at the left and above sides of the lines. All sub-partitions share the same intra mode.

### Template Matching Prediction (TMP)

Template matching prediction (TMP) is a special intra prediction mode that copies the best prediction block from the reconstructed part of the current frame, whose L-shaped template matches the current template. For a predefined search range, the encoder searches for the most similar template to the current template in the reconstructed part of the current frame, and uses the corresponding block as a prediction block (as a reference block). The encoder then signals the usage of this mode, and the inverse operation is made at the decoder side.

### CCLM Overview

The main idea behind CCLM mode (sometimes abbreviated as LM mode) is as follows: chroma components of a block can be predicted from the collocated reconstructed luma samples by linear models whose parameters are derived from already reconstructed luma and chroma samples that are adjacent to the block.

### MMLM Overview

As indicated by the name, the original CCLM mode employs one linear model for predicting the chroma samples from the luma samples for the whole CU, while in MMLM, there can be two models. In MMLM, neighbouring luma samples and neighbouring chroma samples of the current block are classified into two groups, each group is used as a training set to derive a linear model (i.e., particular a and B are derived for a particular group). Furthermore, the samples of the current luma block are also classified based on the same rule for the classification of neighbouring luma samples.

### Convolutional Cross-Component Model (CCCM)

In CCCM, a convolutional model is applied to improve the chroma prediction performance. The convolutional model has 7-tap filter consist of a 5-tap plus sign shape spatial component, a nonlinear term and a bias term. The input to the spatial 5-tap component of the filter consists of a centre luma sample which is collocated with the chroma sample to be predicted and its above/north, below/south, left/west and right/east neighbours.

The filter coefficients are calculated by minimising MSE between predicted and reconstructed chroma samples in the reference area. FIG. 4 illustrates the reference area which consists of 6 lines of chroma samples above and left of the PU. Reference area extends one PU width to the right and one PU height below the PU boundaries. Area is adjusted to include only available samples. The extensions to the area shown in grey are needed to support the “side samples” of the plus shaped spatial filter and are padded when in unavailable areas.

The MSE minimization is performed by calculating autocorrelation matrix for the luma input and a cross-correlation vector between the luma input and chroma output. Autocorrelation matrix is LDL decomposed and the final filter coefficients are calculated using back-substitution. The process follows roughly the calculation of the ALF filter coefficients in ECM, however LDL decomposition was chosen instead of Cholesky decomposition to avoid using square root operations.

### Gradient Linear Model (GLM)

Compared with the CCLM, instead of down-sampled luma values, the GLM utilizes luma sample gradients to derive the linear model. Specifically, when the GLM is applied, the input to the CCLM process, i.e., the down-sampled luma samples L, are replaced by luma sample gradients G.

$$C = α \cdot G + β$$

### Matrix Weighted Intra Prediction (MIP)

Matrix weighted intra prediction (MIP) method is a newly added intra prediction technique in VVC. For predicting the samples of a rectangular block of width W and height H, matrix weighted intra prediction (MIP) takes one line of H reconstructed neighbouring boundary samples left of the block and one line of W reconstructed neighbouring boundary samples above the block as input. If the reconstructed samples are unavailable, they are generated as it is done in the conventional intra prediction. The generation of the prediction signal is based on the following three steps, i.e., averaging, matrix vector multiplication and linear interpolation as shown in FIG. 5. One line of H reconstructed neighbouring boundary samples 512 left of the block and one line of W reconstructed neighbouring boundary samples 510 above the block are shown as dot-filled small squares. After the averaging process, the boundary samples are down-sampled to top boundary line 514 and left boundary line 516. The down-sampled samples are provided to the matric-vector multiplication unit 520 to generate the down-sampled prediction block 530. An interpolation process is then applied to generate the prediction block 540. The generation of the prediction signal is based on the following three steps, which are averaging, matrix vector multiplication and linear interpolation as shown in following.

### 1. Averaging Neighbouring Samples

Among the boundary samples, four samples or eight samples are selected by averaging based on block size and shape. Specifically, the input boundaries bdry^{top} and bdry^{left} are reduced to smaller boundaries

$${bdry}_{red}^{top} and {bdry}_{red}^{left}$$

by averaging neighbouring boundary samples according to predefined rule depends on block size. Then, the two reduced boundaries

$${bdry}_{red}^{top} and {bdry}_{red}^{left}$$

are concatenated to a reduced boundary vector bdry_{red} which is thus of size four for blocks of shape 4×4 and of size eight for blocks of all other shapes.

### 2. Matrix Multiplication

A matrix vector multiplication, followed by addition of an offset, is carried out with the averaged samples as an input. The result is a reduced prediction signal on a subsampled set of samples in the original block. Out of the reduced input vector bdry_{red} a reduced prediction signal pred_{red}, which is a signal on the downsampled block of width W_{red} and height H_{red} is generated.

The reduced prediction signal pred_{red} is computed by calculating a matrix vector product and adding an offset:

$${pred}_{red} = A \cdot {bdry}_{red} + b .$$

Here, A is a matrix that has W_{red}·H_{red} rows and 4 columns if W=H=4 and 8 columns in all other cases. b is a vector of size W_{red}·H_{red}.

### 3. Interpolation

The prediction signal at the remaining positions is generated from the prediction signal on the subsampled set by linear interpolation which is a single step linear interpolation in each direction.

### LFNST Transform Set Selection

There are totally 35 transform sets and 3 non-separable transform matrices (kernels) per transform set in LFNST (Low-frequency non-separable transform) in ECM6.0. The transform set idx lfnstTrSetIdx is defined according to predModeIntra listed in Table 1.

TABLE 1
LFNST transform set selection

| Intra pred. mode | −14 | −13 | −12 | −11 | −10 | −9 | −8 | −7 | −6 | −5 | −4 | −3 | −2 | −1 | 0 | 1 |
|---|---|---|---|---|---|---|---|---|---|---|---|---|---|---|---|---|
| LFNST set index | 2 | 2 | 2 | 2 | 2 | 2 | 2 | 2 | 2 | 2 | 2 | 2 | 2 | 2 | 0 | 1 |

| Intra pred. mode | 2 | 3 | 4 | 5 | 6 | 7 | 8 | 9 | 10 | 11 | 12 | 13 | 14 | 15 | 16 | 17 |
|---|---|---|---|---|---|---|---|---|---|---|---|---|---|---|---|---|
| LFNST set index | 2 | 3 | 4 | 5 | 6 | 7 | 8 | 9 | 10 | 11 | 12 | 13 | 14 | 15 | 16 | 17 |
| Intra pred. mode | 18 | 19 | 20 | 21 | 22 | 23 | 24 | 25 | 26 | 27 | 28 | 29 | 30 | 31 | 32 | 33 |
| LFNST set index | 18 | 19 | 20 | 21 | 22 | 23 | 24 | 25 | 26 | 27 | 28 | 29 | 30 | 31 | 32 | 33 |
| Intra pred. mode | 34 | 35 | 36 | 37 | 38 | 39 | 40 | 41 | 42 | 43 | 44 | 45 | 46 | 47 | 48 | 49 |
| LFNST set index | 34 | 33 | 32 | 31 | 30 | 29 | 28 | 27 | 26 | 25 | 24 | 23 | 22 | 21 | 20 | 19 |
| Intra pred. mode | 50 | 51 | 52 | 53 | 54 | 55 | 56 | 57 | 58 | 59 | 60 | 61 | 62 | 63 | 64 | 65 |
| LFNST set index | 18 | 17 | 16 | 15 | 14 | 13 | 12 | 11 | 10 | 9 | 8 | 7 | 6 | 5 | 4 | 3 |

| Intra pred. mode | 66 | 67 | 68 | 69 | 70 | 71 | 72 | 73 | 74 | 75 | 76 | 77 | 78 | 79 | 80 |
|---|---|---|---|---|---|---|---|---|---|---|---|---|---|---|---|
| LFNST set index | 2 | 2 | 2 | 2 | 2 | 2 | 2 | 2 | 2 | 2 | 2 | 2 | 2 | 2 | 2 |

### Determination of LFNST Transpose Flag

The LFNST transpose flag is determined by predModeIntra as follows:
if predModeIntra is less than or equal to 34, the LFNST transpose flag is set to 0;
else, the LFNST transpose flag is set to 1.

For MIP coded blocks, it is mapped to the PLANAR mode, the LFNST transform set 0 is used and LFNST transpose flag is always equal to 0.

In ECM6.0, LFNST is enable for the MIP coded blocks with the width and height greater than or equal to 16.

### Enhanced MTS for Intra Coding

In the current VVC, for MTS, only DST7 and DCT8 transform kernels are utilized which are used for intra and inter coding.

Additional primary transforms including DCT5, DST4, DST1, and identity transform (IDT) are employed. Also MTS set is made dependent on the TU size and intra mode information. 16 different TU sizes are considered, and for each TU size 5 different classes are considered depending on intra-mode information. For each class, 1, 4 or 6 different transform pairs are considered. Number of intra MTS candidates are adaptively selected (between 1, 4 and 6 MTS candidates) depending on the sum of absolute value of transform coefficients.

### Chroma DM (Direct Mode) Mode

For Chroma DM mode, the intra prediction mode of the corresponding (i.e., collocated) luma block covering the centre position of the current chroma block is directly inherited.

### Intra Block Copy

Intra block copy (IBC) is a tool adopted in HEVC extensions on SCC. It is well known that it significantly improves the coding efficiency of screen content materials. Since IBC mode is implemented as a block level coding mode, block matching (BM) is performed at the encoder to find the optimal block vector (or motion vector) for each CU. Here, a block vector is used to indicate the displacement from the current block to a reference block, which is already reconstructed inside the current picture.

### Inter Prediction Overview

According to JVET-T2002 Section 3.4. (Jianle Chen, et. al., “Algorithm description for Versatile Video Coding and Test Model 11 (VTM 11)”, Joint Video Experts Team (JVET) of ITU-T SG 16 WP 3 and ISO/IEC JTC 1/SC 29, 20th Meeting, by teleconference, 7-16 Oct. 2020, Document: JVET-T2002)), for each inter-predicted CU, motion parameters consist of motion vectors, reference picture indices and reference picture list usage index, and additional information needed for the new coding feature of VVC to be used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU, which are obtained from neighbouring CUs, including spatial and temporal candidates, and additional schedules introduced in VVC. The merge mode can be applied to any inter-predicted CU, not only for skip mode. The alternative to the merge mode is the explicit transmission of motion parameters, where motion vector, corresponding reference picture index for each reference picture list and reference picture list usage flag and other needed information are signalled explicitly per each CU.

Beyond the inter coding features in HEVC, VVC includes a number of new and refined inter prediction coding tools listed as follows:
Extended merge prediction
Merge mode with MVD (MMVD)
Symmetric MVD (SMVD) signalling
Affine motion compensated prediction
Subblock-based temporal motion vector prediction (SbTMVP)
Adaptive motion vector resolution (AMVR)
Motion field storage: 1/16^{th} luma sample MV storage and 8×8 motion field compression
Bi-prediction with CU-level weight (BCW)
Bi-directional optical flow (BDOF)
Decoder side motion vector refinement (DMVR)
Geometric partitioning mode (GPM)
Combined inter and intra prediction (CIIP)

The following text provides the details on those inter prediction methods specified in VVC.

### Extended Merge Prediction

In VVC, the merge candidate list is constructed by including the following five types of candidates in order:
1) Spatial MVP from spatial neighbour CUs
2) Temporal MVP from collocated CUs
3) History-based MVP from an FIFO table
4) Pairwise average MVP
5) Zero MVs.

### Spatial Candidates Derivation

The derivation of spatial merge candidates in VVC is same to that in HEVC except the positions of first two merge candidates are swapped. A maximum of four merge candidates for current CU 610 are selected among candidates located in the positions depicted in FIG. 6. The order of derivation is B₀, A₀, B₁, A₁ and B₂. Position B₂ is considered only when one or more than one CU of position B₀, A₀, B₁, A₁ are not available (e.g., because it belongs to another slice or tile) or is intra coded. After candidate at position A₁ is added, the addition of the remaining candidates is subject to a redundancy check which ensures that candidates with same motion information are excluded from the list so that coding efficiency is improved.

To reduce computational complexity, not all possible candidate pairs are considered in the mentioned redundancy check. Instead, only the pairs linked with an arrow in FIG. 7 are considered and a candidate is only added to the list if the corresponding candidate used for redundancy check does not have the same motion information.

### Temporal Candidates Derivation

In this step, only one candidate is added to the list. Particularly, in the derivation of this temporal merge candidate for a current CU 810, a scaled motion vector is derived based on the co-located CU 820 belonging to the collocated reference picture as shown in FIG. 8. The reference picture list and the reference index to be used for the derivation of the co-located CU is explicitly signalled in the slice header. The scaled motion vector 830 for the temporal merge candidate is obtained as illustrated by the dotted line in FIG. 8, which is scaled from the motion vector 840 of the co-located CU using the POC (Picture Order Count) distances, tb and td, where tb is defined to be the POC difference between the reference picture of the current picture and the current picture and td is defined to be the POC difference between the reference picture of the co-located picture and the co-located picture. The reference picture index of temporal merge candidate is set equal to zero.

The position for the temporal candidate is selected between candidates C₀ and C₁, as depicted in FIG. 9, where box 910 corresponds to a luma (Y) block. If CU at position C₀ is not available, is intra coded, or is outside of the current row of CTUs, position C₁ is used. Otherwise, position C₀ is used in the derivation of the temporal merge candidate.

### History-Based Merge Candidate Derivation

In this method, the motion information of a previously coded block is stored in a table and used as MVP for the current CU. The table with multiple HMVP candidates is maintained during the encoding/decoding process. The table is reset (emptied) when a new CTU row is encountered. Whenever there is a non-subblock inter-coded CU, the associated motion information is added to the last entry of the table as a new HMVP candidate.

The HMVP table size Sis set to be 6, which indicates up to 5 History-based MVP (HMVP) candidates may be added to the table. When inserting a new motion candidate to the table, a constrained first-in-first-out (FIFO) rule is utilized wherein redundancy check is firstly applied to find whether there is an identical HMVP in the table. If found, the identical HMVP is removed from the table and all the HMVP candidates afterwards are moved forward, and the identical HMVP is inserted to the last entry of the table.

HMVP candidates could be used in the merge candidate list construction process. The latest several HMVP candidates in the table are checked in order and inserted to the candidate list after the TMVP candidate. Redundancy check is applied on the HMVP candidates to the spatial or temporal merge candidate.

### Non-Adjacent Spatial Candidate

The pattern of spatial merge candidates is shown in FIG. 10. The distances between non-adjacent spatial candidates and current coding block are based on the width and height of current coding block. The line buffer restriction is not applied.

In the present invention, methods and apparatus of blending intra matric prediction mode with various settings are disclosed to improve the performance.

### BRIEF SUMMARY OF THE INVENTION

A method and apparatus for video coding using Matrix-based Intra Prediction (MIP) mode with various settings are disclosed. According to the method, input data associated with a current block are received, wherein the input data comprise pixel data to be encoded at an encoder side or data associated with the current block to be decoded at a decoder side. A target Matrix-based Intra Prediction (MIP) mode is determined using an MIP mode setting, wherein the MIP mode setting incorporates blending setting, transposing setting, representative mode setting, inheriting setting, or a combination thereof, wherein the MIP mode setting with the blending setting includes a blended matrix candidate formed by combining two or more hypotheses of predictions, wherein the MIP mode setting with the transposing setting includes a transposed matrix candidate generated by transposing one or more matrix coefficients or one or more reference samples, wherein the MIP mode setting with the representative mode setting includes a representative mode generated according to the representative mode setting, or wherein the MIP mode setting with the inheriting setting includes an inherited MIP candidate. The current block is encoded or decoded using the target MIP mode.

In one embodiment, the target MIP mode is used as an additional mode or a replacement mode.

In one embodiment, when the blending setting is used, said one or more hypotheses of predictions are generated according to one or more pieces of matrix information. In one embodiment, combining weighting for the blended matrix candidate is block-based weighting. In another embodiment, combining weighting for the blended matrix candidate is sample-based or position-based weighting. In yet another embodiment, said one or more pieces of matrix information are obtained by using a suggestion scheme to select from a set of candidate matrix information, and wherein the set of candidate matrix information includes all or any subset of inheriting matrix information.

In one embodiment, said one or more matrix coefficients or said one or more reference samples are transposed as one or more additional candidate matrixes for the current block.

In one embodiment, the representative mode is generated according to DIMD (Decoder-side Intra Mode Derivation) or TIMD (Template-based Intra Mode Derivation). In another embodiment, the representative mode is generated according to block width, block height, block area or a combination thereof. In yet another embodiment, the representative mode is used to select a transform set of separable or non-separable primary or secondary transforms for the current block. In yet another embodiment, the representative candidate is used by one or more subsequent blocks after the current block. In yet another embodiment, the representative mode is used as chroma DM (Direct Mode) of a subsequent chroma block. In yet another embodiment, the representative mode is used as MPM (Most Probable Mode) of one or more subsequent intra or inter blocks.

In one embodiment, when the inheriting setting is used, matrix information is recorded. In one embodiment, the matrix information comprises matrix size, matrix mode index, transposing information, target information for the target MIP mode to determine one or more predictors, or a combination thereof. In one embodiment, an inheriting list is built for the current block. In one embodiment, an inheriting index is signalled, parsed or inferred to indicate target matrix information from the inheriting list. In one embodiment, the target matrix information indicated by the inheriting index is used for the current block to generate a target MIP predictor. In one embodiment, if one or more matrix sizes of the target matrix information are not belonging to a block size category of the current block, down-sampling or up-sampling setting is applied.

### BRIEF DESCRIPTION OF THE DRAWINGS

FIG. 1A illustrates an exemplary adaptive Inter/Intra video encoding system incorporating loop processing.

FIG. 1B illustrates a corresponding decoder for the encoder in FIG. 1A.

FIG. 2A illustrates an example of selected template for a current block, where the template comprises T lines above the current block and T columns to the left of the current block.

FIG. 2B illustrates an example for T=3 and the HoGs (Histogram of Gradient) are calculated for pixels in the middle line and pixels in the middle column.

FIG. 2C illustrates an example of the amplitudes (ampl) for the angular intra prediction modes.

FIG. 3 illustrates an example of template-based intra mode derivation.

FIG. 4 illustrates an example of reference area with paddings used to derive the filter coefficients.

FIG. 5 illustrates an example of processing flow for Matrix weighted intra prediction (MIP).

FIG. 6 illustrates the neighbouring blocks used for deriving spatial merge candidates for VVC.

FIG. 7 illustrates the possible candidate pairs considered for redundancy check in VVC.

FIG. 8 illustrates an example of temporal candidate derivation, where a scaled motion vector is derived according to POC (Picture Order Count) distances.

FIG. 9 illustrates the position for the temporal candidate selected between candidates C₀ and C₁.

FIG. 10 illustrates an exemplary pattern of the non-adjacent spatial merge candidates.

FIG. 11A illustrates an example of the initial reference samples for regular MIP.

FIG. 11B illustrates an example of the initial reference samples including the top N samples non-adjacent to the current block and/or the left M samples non-adjacent to the current block.

FIG. 12A illustrates an example of the initial reference samples for IBC-/intra TMP-/inter-MIP.

FIG. 12B illustrates an example of the initial reference samples referring to the current reconstructed samples of the collocated region for the current block.

FIG. 13 illustrates an example of PDPC further used to adjust the predictors for the current block.

FIG. 14A illustrates an example of applying histogram analysis on the spatially neighbouring reconstructed samples.

FIG. 14B illustrates an example of applying template analysis on the spatially neighbouring reconstructed samples.

FIG. 15A illustrates an example of template including a top template, a left template and a top-left template.

FIG. 15B illustrates an example of template include an extended top template and an extended left template.

FIG. 16 illustrates an example of DIMD/TIMD on current predictors as the intra prediction mode for transform, where the centre of window is applied on the samples (in grey area) within the current (or reduced) block but not located at the boundary of the current (or reduced) block.

FIG. 17 illustrates an example of the intra prediction mode for transform, where five prediction units in the reference region are pre-defined and a scanning order is applied to the pre-defined prediction units.

FIG. 18 illustrates an example of boundary cost evaluation between the current prediction within the current block and the neighbouring reconstruction within one or more neighbouring blocks.

FIG. 19 illustrates a flowchart of an exemplary video coding system where the MIP mode uses one or more settings according to an embodiment of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

In order to improve the coding performance of Matrix-based Intra Prediction, various settings are disclosed.

In this invention, when a target mode is used for the current block, a down-sampling mechanism, an up-sampling mechanism, a transposing mechanism, an inheriting mechanism, a side-oriented mechanism, a blending mechanism, and/or a block-splitting mechanism is proposed to provide the candidates for this target mode. The proposed mechanism may slightly or totally not increase the number of circuits/tables/storage/matrixes, which were originally supported in the functionality of this target mode, and can derive more candidates for the target mode. The target mode in this invention refers to a matrix-based (or matrix weighted) prediction mode as an example. However, the proposed methods are not limited to only applying to the matrix-based prediction mode and may be used for any prediction mode with intra/inter/a third mode type (e.g., IBC). For the target mode being the matrix-based prediction mode, multiple matrixes (or tables) are pre-defined and when one matrix is indicated to be selected for the current block, the selected matrix and one or more reference samples are used to generate the prediction of the current block. An example is shown in the following expression.

$$Pred = Matrix \cdot ReferenceSample + offset + Bias \qquad ( 1 )$$

The reference samples include:
reconstructed or predicted samples or any pre-defined information in spatial neighbouring blocks adjacent or non-adjacent to the current block, for example, the left side and/or above side of the current block
reconstructed or predicted samples or any pre-defined information in temporal collocated blocks or in any pre-defined region for the current block or in one or more previous pictures
or any subset or both of the above-mentioned reference samples.

For example, when the reference samples refer to the spatial neighbouring reconstructed samples adjacent to the current block and the current block is coded by intra, the target mode refers to regular “Matrix Weighted Intra Prediction” (MIP) mode. For another example, when the reference samples refer to the spatial neighbouring reconstructed samples adjacent to the current block and the current block is coded by inter, the target mode refers to inter regular MIP mode. For another example, when the reference samples refer to the spatial neighbouring reconstructed samples non-adjacent to the current block and the current block is coded by intra, the target mode refers to “Multiple Reference Line with Regular MIP” (MRL-MIP) mode. That is, MRL based MIP mode uses reference samples comprising spatial neighbouring reconstructed samples non-adjacent to the current block. For another example, when the reference samples refer to the spatial-neighbouring reconstructed or predicted samples and/or current reconstructed or predicted samples of the collocated region for the current block, the target mode refers to:
IBC-MIP if the collocated region is found by block vectors of the current block (like what IBC does)
IntraTMP-MIP if the collocated region is found by template matching/searching in a pre-defined range (like what intraTMP does)
Inter-MIP if the collocated region is found by motion information of the current block (like what inter does)

In the above-mentioned MIP variations, IBC or IntraTMP based MIP mode uses reference samples comprising reconstructed samples indicated by one or more block vectors of the current block, the inter based MIP mode uses reference samples comprising reconstructed samples indicated by one or more motion vectors of the current block or reconstructed samples in one or more previous pictures, and/or the reference samples are reconstructed samples for easy explanation, but it is not limited to use the reconstructed samples as the reference samples. The Steps in the following are described in details to introduce how to generate predictors for the current block. All, any subset, or any extension of the steps can be used to generate the predictors for the target mode in this invention.

Step 0: For different block sizes (width×height as N×M), different matrixes are pre-defined. In one embodiment, the matrix for the current block is pre-defined depending on the block size and/or block shape for the current block. The following shows an example of categorizing the block size into 3 categories. The proposed methods are not limited to applying to this example. The number of categories can be any pre-defined positive integer.
For example, for blocks with size (categorized in S0), N is 4 (or the smallest block size), M is 4 (or the smallest block size), and K0 candidate matrixes are pre-defined with the dimension of each candidate matrix being n0×m0.
For another example, for blocks with size (categorized in S1), N×M is 4×8, 8×4, 8×8, 4×M, or N×4, and K1 candidate matrixes are pre-defined with the dimension of each candidate matrix being n1×m1.
For another example, for blocks with sizes (categorized in S2), N×M is the remaining size and K2 candidate matrixes are pre-defined with the dimension of each candidate matrix being n2×m2.
K0, K1, and K2 can be any pre-defined values such as 1, 2, 3, 4, etc. m0, m1, and m2 are the matrix input size for S0, S1, and S2 respectively. n0, n1, and n2 are the matrix output size for S0, S1, and S2 respectively. A table in the following shows an example of different block sizes with different numbers of candidate matrixes.

The different block sizes (width×height as N×M) and different matrixes are pre-defined for categories S0, S1 and S2 in Table 2.

TABLE 2
Different block sizes and different matrixes are pre-defined for categories S0, S1 and S2

| Category | S0 | S1 | S2 |
|---|---|---|---|
| Block size | 4 × 4 (S0, small) | 4 × 8, 8 × 4, 8 × 8, 4 × M, | All others (S2, large) |
| | | N × 4 (S1, medium) | |
| # of matrixes | K0 (16) | K1 (8) | K2 (6) |
| Matrix size | n0 (16) × m0 (4) | n1 (16) × m1 (8) | n2 (64) × (m2 (8) or |
| | | | m2 − 1) |
| Offset vector size | n0 (16) | n1 (16) | n2 (64) |

In one embodiment, the matrix is not indicated by a signalled index and is inferred for the current block when only one candidate matrix is available for the current block.

Step 1: The input reference samples for the matrix are derived by using initial reference samples.

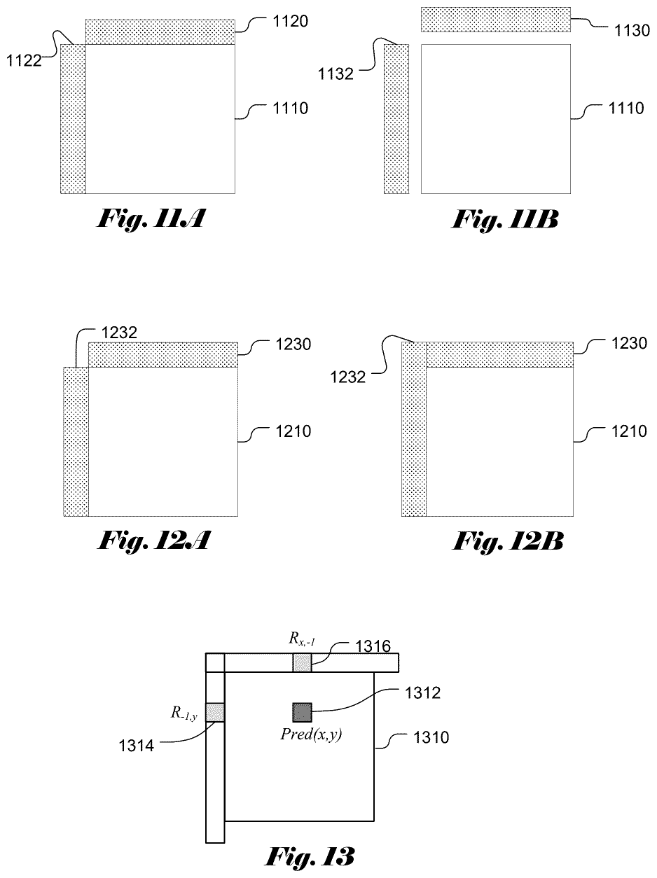

Step 1-0: Several embodiments are proposed to prepare the initial reference samples. In one embodiment, the initial reference samples are not filtered by reference smoothing filter such as [1, 2, 1] filtering.
FIG. 11A shows an example of the initial reference samples for regular MIP, where block 1110 corresponds to the current block. The initial reference samples refer to the neighbouring reconstructed samples adjacent to the current block. In FIG. 11A, the initial reference samples include the top N-row samples 1120 adjacent to the current block (from reference line 0) and/or the left M-column samples 1122 adjacent to the current block (from reference line 0). In one embodiment (as shown in FIG. 11B), the initial reference samples include the top N-row samples 1130 non-adjacent to the current block (from the reference line greater than 0) and/or the left M-column samples 1132 non-adjacent to the current block (from reference line greater than 0). In another embodiment, the size of the initial reference samples for top or left can be extended to any value smaller than or equal to (N+M)*k where k can be any positive integer larger than or equal to 1. In another embodiment, the size of the initial reference samples for the top region can be extended to any value smaller than or equal to N*k, where k can be any positive integer larger than or equal to 1. In another embodiment, the size of the initial reference samples for the left region can be extended to any value smaller than or equal to M*k where k can be any positive integer larger than or equal to 1. All or any subset of the samples in the top, left, or both regions can be used as the reference samples for MIP.
FIG. 12A shows an example of the initial reference samples for IBC-/intraTMP-/inter-MIP, where block 1210 corresponds to a collocated region. The collocated region may have the same size as the current block and the initial reference samples are derived according to the above-mentioned methods for regular MIP (i.e., the initial reference samples include the top N-row samples 1220 adjacent to the current block (from reference line 0) and/or the left M-column samples 1222 adjacent to the current block (from reference line 0)). In one embodiment (as shown in FIG. 12B), the initial reference samples refer to the current reconstructed samples (1230 and 1232 in FIG. 12B) of the collocated region for the current block. In one sub-embodiment, if the collocated region has the larger (or smaller) size than the current block, down-sampling (or up-sampling) operations are used to get the initial reference samples.

In one embodiment, when preparing the initial reference samples for the current block, availability of neighbouring reconstructed samples is checked and then the unavailable samples are padded from the available samples. The operations in this step are unified with what does in regular intra prediction mode.

Step 1-1: The size of the input reference sample is associated with the matrix size (m0, m1, or m2). For S0, size=2 at left and/or top side. In details, the size equal to 2 means 2 from top and 2 from left so m0 is 4. In one embodiment, m0 is set as any value smaller than 4. For example, size=1 for S0 at left and top sides. m0 is set as 2. For S1 and/or S2, size=4 at left and/or top side. The size equal to 4 means 4 from top and 4 from left so m1 and/or m2 are 8. In one embodiment, m1 and/or m2 are set as any values smaller than 8.

Step 1-2: If the size of the input reference samples is smaller than the size of the initial reference samples, down-sampling operations are used and the down-sampling factor is set as (the size of initial reference samples/the size input reference samples). An example of the down-sampling operations is shown in the following expression (2).

$$inputReferenceSample [ x ] = ( {\sum }_{i = 0}^{downSampleFactor - 1} initialReferenceSample [ x * downSampleFactor + i ] + ( 1 ≪ ( Log 2 ( downSampleFactor ) - 1 ) ) ) ≫ Log 2 ( downSampleFactor ) \qquad ( 2 )$$

Several embodiments are proposed to define different down-sampling operations. In one embodiment, a sub-sampling method is used as the down-sampling operation. That is, for each x, a representative sample value is set as the pre-defined one of the sample in initialReferenceSample[x*downSampleFactor+i] instead of averaging all samples in initialReferenceSample[x*downSampleFactor+i]. For example, the pre-defined one of the samples refers to a medium/mean/maximum/minimum value in initialReferenceSample[x*downSampleFactor+i]. For example, the pre-defined one of the samples refers to a popular value which exists most in initialReferenceSample[x*downSampleFactor+i]. In another embodiment, a filtering method is used to generate a representative sample value in initialReferenceSample[x*downSampleFactor+i]. The filtering may refer to a Gaussian filtering, a cubic filtering, any low-pass filtering and/or any filtering supported in the standard. In one sub-embodiment, the filtering tap is 2, 4, 6, 8, or any pre-defined value. The length of the filtering tap is different from (i.e., longer than or shorter than) the intra and/or inter and/or a third mode type prediction, or unified with the intra and/or inter and/or a third mode type prediction. The proposed methods can be used for any other down/up sampling operations in this invention. The Step 1-2 is applied to the left side and/or above side, respectively. Then, all or any subset of input reference samples from the left side and/or above side are connected as bdry_{red}[i], where i is from 0 to (m0, m1, or m2)−1 (denoted as (m0/m1/m2)−1) for S0/S1/S2 respectively and slightly adjusted to form a vector used as the input reference samples for the matrix as input [i].

Step 2: The input reference samples for the matrix are multiplied with the matrix coefficients and used for generating the initial predictors for the current block. For example,

$$initialPred [ x ] [ y ] = ( ( ( {\sum }_{i = 0}^{( m 0 / m 1 / m 2 ) - 1} Matrix [ i ] [ y * log 2 ( n 0 / n 1 / n 2 ) + x ] \cdot inputRef [ i ] ) + offset ) ≫ 6 ) + {bdry}_{red} [ 0 ]$$

$$where offset = 32 - 32 \cdot ( {\sum }_{i = 0}^{( m 0 / m 1 / m 2 ) - 1} inputRef [ i ] ) or$$

$$initialPred [ x ] [ y ] = ( ( ( {\sum }_{i = 0}^{( m 0 / m 1 / m 2 ) - 1} ( Matrix [ i ] [ y * log 2 ( n 0 / n 1 / n 2 ) + x ] - 32 ) \cdot inputRef [ i ] ) + 32 ) \underline{≫ 6} ) + {bdry}_{red} [ 0 ]$$

The initial predictors are post-processed with a clip operation to make the predictor values within a pre-defined bit range. For example, the pre-defined bit range is from 0 to (1<<bitDepth for luma or chroma). If the current block refers to a luma coding block, the bitDepth for luma is used; otherwise, the bitDepth for chroma is used.

Step 3: The initial predictors are up-sampled (or down-sampled) if the n0/n1/n2 are smaller (or larger) than the size of the current block. For example, the bilinear interpolation filter is used and a pre-defined order is set to perform horizontal filtering and then perform vertical filtering, or to perform vertical filtering and then perform horizontal filtering.

In one embodiment, when the down-sampling and/or up-sampling mechanisms are used to provide the candidates of the target mode, one or more matrixes for the block size categories (different from the block size category for the current block) are available for the current block as additional candidate matrixes for the current block or available for the current block as the replacement candidate matrixes for the current block to replace one or more existing matrixes for the current block. For example, when a target block size associated with the target block size category is smaller than a regular block size associated with a regular block size category for a regular MIP mode, reference samples from the top side, left side, or both, of the current block are down-sampled more than the regular MIP mode. For example, when a target block size associated with the target block size category is larger than a regular block size associated with a regular block size category for a regular MIP mode, reference samples from the top side, left side, or both, of the current block are up-sampled more than the regular MIP mode.

For an example of the current block being categorized in S0 (as a regular case or a regular MIP mode), originally only the matrixes with size equal to n0×m0 are available; with the proposed methods, the matrixes with size equal to n1×m1 and/or the matrixes with size equal to n2×m2 are available. The following shows a target block size associated with the target block size category is larger than a regular block size associated with a regular block size category for the regular case. When using the matrixes from S1 and/or S2, the following methods are proposed. If the current block is 4×4 and m1 or m2 is set as 8, which implies 4 for the top and 4 for the left, all neighbouring reference samples adjacent to the top side and left side of the current block are used as the initial and/or input reference samples. In one sub-embodiment, if m1 or m2 is set as a value larger than the size of the prepared initial reference samples for the current block, the prepared initial reference samples for the current block are up-sampled to match the m1 or m2. In another sub-embodiment, if m1 or m2 is set as a value larger than size of the input reference samples for the current block, the input reference samples for the current block are up-sampled to match the m1 or m2. In another sub-embodiment, if the n1 or n2 is set as a value larger than the size of the current block, the initial predictors are down-sampled to match the size of the current block.

For an example of the current block being categorized in S1 (as a regular case or a regular MIP mode), originally only the matrixes with size equal to n1×m1 are available; with the proposed methods, the matrixes with size equal to n0×m0 and/or the matrixes with size equal to n2×m2 are available. When using the matrixes from S0 and/or S2, the following methods are proposed. In one sub-embodiment, if m0 is set as a value smaller than the size of the prepared initial and/or input reference samples for the current block, the prepared initial and/or input reference samples for the current block are down-sampled to match the m0. If the current block is 8×8 and m0 is set as 4, which implies a down-sampling factor, which can get 2 reference samples for the top and 2 reference samples for the left, neighbouring reference samples adjacent to the top side and left side of the current block are down-sampled more than regular to get the initial and/or input reference samples. When deriving the input reference samples for the current block, the down-sampling factor is set as (the size of initial reference samples/2 (instead of original 4)) for one side. That is, a larger down-sampling factor is used instead. In original S1 category, for one side, the 8×8 block has 8 samples down-sampled to 4 samples (due to m1=8 implying 4 samples from one side) with the down-sampling factor as 2 which can be calculated by 8/4. With the proposed methods to use S0 category smaller than original S1, for one side, the 8×8 block has 8 samples down-sampled to 2 samples (due to m0=4 implying 2 samples from one side) with the down-sampling factor as 4 which can be calculated by 8/2. In another sub-embodiment, if n0 is set as a value smaller than n1, the initial predictors are up-sampled more to match the size of the current block. In another sub-embodiment, if m2 is set as a value larger than size of the prepared initial reference samples for the current block, the prepared initial reference samples for the current block are up-sampled to match m2. In another sub-embodiment, if m2 is set as a value larger than the size of the input reference samples for the current block, the input reference samples for the current block are up-sampled to match m2. In another sub-embodiment, if n2 is set as a value larger than size of the current block, the initial predictors are down-sampled to match the size of the current block.

For an example of the current block being categorized in S2 (as a regular case or a regular MIP mode), originally only the matrixes with size equal to n2×m2 are available; with the proposed methods, the matrixes with size equal to n0×m0 and/or the matrixes with size equal to n1×m1 are available. The following shows a target block size associated with the target block size category is smaller than a regular block size associated with a regular block size category for the regular case. When using the matrixes from S0 and/or S1, the following methods are proposed. In one sub-embodiment, if m0 or m1 is set as a value smaller than the size of the prepared initial and/or input reference samples for the current block, the prepared initial and/or input reference samples for the current block are down-sampled to match m0 or m1. If the current block is 16×16 and m0 is set as 4, which implies a down-sampling factor, which can get 2 reference samples for the top and 2 reference samples for the left, neighbouring reference samples adjacent to the top side and left side of the current block are down-sampled more than regular to get the initial and/or input reference samples. When deriving the input reference samples for the current block, the down-sampling factor is set as (the size of initial reference samples/2 (instead of original 4)) for one side. That is, a larger down-sampling factor is used instead. In original S2 category, for one side, the 16×16 block has 16 samples down-sampled to 4 samples (due to m2=8 implying 4 samples from one side) with the down-sampling factor as 4 which can be calculated by 16/4. With the proposed methods to use S0 category smaller than original S2, for one side, the 16×16 block has 16 samples down-sampled to 2 samples (due to m0=4 implying 2 samples from one side) with the down-sampling factor as 8 which can be calculated by 16/2. In another sub-embodiment, if n0 or n1 is set as a value smaller than n2, the initial predictors are up-sampled more to match the size of the current block.

In another embodiment, when the transposing mechanism is used to provide the candidates of the target mode, one or more matrix coefficients or one or more reference samples are transposed as additional candidate matrixes for the current block or as the replacement candidate matrixes, which replace one or more existing matrixes. When applying the transposing mechanisms to the reference samples, several embodiments are proposed. In one embodiment, if originally the input reference samples for the top are connected following the input reference samples for the left, now the input reference samples for the left are connected following the input reference samples for the top; or if originally the input reference samples for the left are connected following the input reference samples for the top, now the input reference samples for the top are connected following the input reference samples for the left. In another embodiment, the initial predictors are transposed. For example, predTemp[y][x]=initialPred[x][y] and initialpred=predTemp.

In another embodiment, when the side-oriented mechanism is used to provide the candidate of the target mode, the reference samples are from either the top side or the left side. Originally, the reference samples are from both the left and top sides. With the proposed methods, the reference samples focus on the information of one side. For example, two lines from the top are referenced. One line is original line 0 from the top and the other line is any pre-defined line i (i>0) from the top. For another example, two lines of from the left are referenced. One line is original line 0 from the left and the other line is any pre-defined line i (i>0) from the left. The two lines can be adjacent or non-adjacent to each other.

In another embodiment, when the inheriting information is used to provide the candidate of the target mode, all or any subset or any combination of the following methods are applied. First, the coded information for the previous coded blocks is recorded as follows. For each coding block using the target mode, the matrix information is recorded. The matrix information comprises matrix size, matrix mode index, transposing information, target information for the target MIP mode to determine one or more predictors, or a combination thereof. To be more specific, the matrix information may include the matrix size, matrix mode index (indicating which matrix being used), transposing or not, all or any subset of the reference samples used in the matrix, any information for the target mode to get predictors, and/or any subset or extension of the above-mentioned matrix information (for example, matrix coefficients or any information of getting the matrix coefficients belonging to the matrix information). In one embodiment, one or more history-based tables are built to store the matrix information after each coding block using the target mode. For example, different history-based tables are associated with different block sizes. For another example, different history-based tables are associated with different matrix sets. For another example, different history-based tables are associated with different block properties. For another example, only one history-based table is used. For the current block, the history-based matrix candidates from the one or more history-based matrix tables are added to the inheriting list or set after a set of pre-defined matrix candidates. For example, the set of pre-defined matrix candidates include the adjacent and/or non-adjacent spatial candidates or any subset of the above. In this method, the matrix information of a previously coded block is stored in the one or more tables and used as the matrix information for the current block or used to derive the matrix information for the current block. The one or more tables with multiple history-based matrix candidates are maintained during the encoding and/or decoding process. The one or more tables are reset (or emptied) when a new CTU row or any-pre-defined range, which is fixed in the standard and/or determined by block-level and/or high-level syntax in the bitstream, is encountered. The table size is any-pre-defined value, which is fixed in the standard and/or determined by block-level and/or high-level syntax in the bitstream and/or related to the size of the inheriting list or set.

When inserting a new candidate to the table, a constrained first-in-first-out (FIFO) rule is utilized, wherein redundancy check is firstly applied to find whether there is an identical candidate in the table. If found, in one sub-embodiment, the identical candidate is removed from the table and all the candidates afterwards are moved forward, and the identical candidate is inserted to the last entry of the table. The candidates may be used in the inheriting list or set construction process. The latest several candidates in the table are checked in order and inserted to the inheriting list or set after the set of pre-defined matrix candidates. Full or partial redundancy check is applied on the history-based candidates to the previous-existing candidates in the inheriting list or set (e.g., the set of pre-defined matrix candidates). In another embodiment, to reduce the number of redundancy check operations, the following simplifications are proposed. For example, the last K entries in the table are redundancy checked with a pre-defined set of spatial candidates (not all spatial candidates). For another example, if the total number of inheriting candidates reaches a number (i.e., the maximum allowed candidates minus 1), the inheriting list or set construction process from the one or more history-based tables is terminated. In another embodiment, second, for the current block, an inheriting list or set is built by searching all or any subset of the coded blocks in a pre-defined range. In one embodiment, the pre-defined range refers to the current picture, slice, CTU, tile, or any pre-defined region located at the current picture. In another embodiment, the pre-defined range is derived based on the current block. For example, the pre-defined range is a coded top range and/or coded left range around the current block. For another example, the pre-defined range follows the pattern of non-adjacent candidates. That is, the distances between non-adjacent spatial candidates and the current block depend on the width and/or height of the current block. In another embodiment, the pre-defined range is limited by CTU row. For example, if the current block is at top row inside a CTU row, the current block has a smaller range by not using much coded top range. In another embodiment, the pre-defined range is not limited to located in the current picture. The pre-defined range can be derived based on the position of the current block and/or may be or may not be in the current picture. When a coded block in the pre-defined range has the matrix information and satisfies a valid checking, the matrix information for the coded block is put into the inheriting list or set. In one embodiment, the valid checking includes the matrix input size (m) being larger than or equal to the current block size, which implies that the reference samples for the current block are not enough to use that matrix. That is, the valid checking depends on the input size of the to-be-put matrix, which may be inserted into the list or set if the valid checking is satisfied, and/or the size of the current block. In another embodiment, the valid checking includes the matrix output size (n) being smaller than or equal to the current block size. That is, the valid checking depends on the output size of the to-be-put matrix and/or the size of the current block. In another embodiment, the valid checking includes the to-be-put matrix information is not duplicated with all or any subset of the members already in the inheriting list or set. For example, full or partial pruning is used. In another embodiment, the order of the members in the inheriting list or set follows the searching order in the pre-defined range. In another embodiment, the matrix information selected by most coded blocks in the pre-defined range is put in the front of the inheriting list or set. Third, an inheriting index is signalled and/or parsed and/or inferred to indicate one or more pieces of matrix information from the inheriting list or set. Then, the indicated matrix information is used for the current block to generate predictors. If the matrix sizes of the indicated matrix information are not for or not belonging to the block size category of the current block, the proposed methods of down-sampling and/or up-sampling mechanisms can be applied here. In another embodiment, if a chroma block, for example, in a chroma DM mode, references the collocated luma block, which was coded by a matrix-based mode, the chroma block can inherit the matrix information from the collocated luma block. When the colour format is not 4:4:4 (e.g., 4:2:0), the chroma has a different block size from the luma. Therefore, the proposed methods of down-sampling and/or up-sampling mechanisms can be applied here to support using inherited matrix information for chroma blocks.

In another embodiment, when the blending mechanism is used to provide the candidates of the target mode, the candidate using the blending mechanism is treated as an additional sub-mode for the target mode or treated to replace the prediction generation of the target mode. When the blending mechanism is applied to the current block using the target mode, several embodiments are proposed to generate the predictor for the current block. In one embodiment, the predictors for the current block are formed by combining one or more hypotheses of predictions generated according to one or more pieces of matrix information. In one sub-embodiment, the combining weighting is block-based weighting (i.e., uniform for the whole block). In another sub-embodiment, the combining weighting is sample-based weighting (i.e., deriving weighting for each sample) or position-based weighting. In another embodiment, the one or more pieces of matrix information are obtained by using a suggestion scheme to select from a set of candidate matrix information. The set of candidate matrix information may include all or any subset of the inheriting matrix information. The set of candidate matrix information may include all or any subset of the candidate matrix information of the current block. The suggestion scheme may refer to a boundary matching scheme, a template matching scheme (for example, DIMD and/or TIMD), a pre-defined mapping table which stores the candidate information associated with different block sizes. For an example of the suggestion scheme being boundary matching scheme, for each candidate matrix information in the set, a boundary matching cost is calculated and the first K candidates with smaller boundary matching costs (as described later in this disclosure) are used for generating predictors for the current block. The hypothesis of prediction from the candidate with a smaller cost has a higher weight (similar to TIMD). For another example of the suggestion scheme being the boundary matching scheme, one or more pieces of matrix information are suggested from the top boundary and another one or more pieces of matrix information are suggested from the left boundary. The hypothesis of prediction from the candidate suggested by the top boundary has a higher weight if the current sample is near the top boundary. The hypothesis of prediction from the candidate suggested by the left boundary has a higher weight if the current sample is near the left boundary. The weighting for the current sample may depend on the position of the current sample. An example of the weighting is shown below:

$${w}_{matrixTop} ( x , y ) + {w}_{matrixLeft} ( x , y ) = 64 ,$$

$${w}_{matrixTop} ( x , y ) = 32 + \frac{32 x}{width} - \frac{32 y}{height} .$$

If the matrix suggested from either the left or top boundary corresponds to a large boundary cost, the position-dependent weighting is further adjusted to reduce the weighting for the matrix with a very large boundary matching cost.

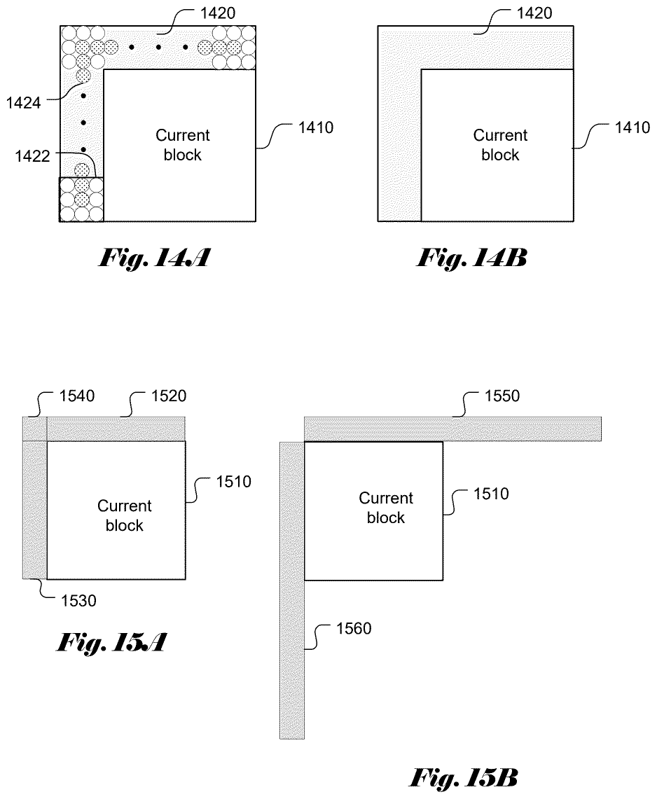

In another embodiment, the predictors for the current block are further combined with one or more hypotheses of predictions generated by one or more traditional intra prediction modes. In one sub-embodiment, the one or more traditional intra prediction modes are determined by TIMD, boundary matching, and/or DIMD suggestion. In another sub-embodiment, the one or more traditional intra prediction modes include at least planar, DC, horizontal, vertical, diagonal, any intra prediction mode in 67 and/or 131 domain, any intra prediction mode supported in the standard, or any subset of the above-mentioned modes. In another sub-embodiment, if the size of the current block is larger than or smaller than a pre-defined threshold (e.g., 4, 8, 16, 32, 64, . . . ), the used traditional intra prediction mode is a fixed default mode (e.g., planar); otherwise, the used traditional intra prediction mode is determined with the suggestion. In another embodiment, PDPC is further used to adjust the predictors for the current block 1310 as shown in FIG. 13. The horizontal neighbouring reconstructed samples (R_{-1,y}) 1314 and/or vertical neighbouring reconstructed samples (R_{x,-1}) 1316 are used to adjust the predictor(x, y) 1312. An example for PDPC adjustment is shown as follows:

$$Pred ( x , y ) = ( ( ( ( wT \times {R}_{x , - 1} + wL \times {R}_{- 1 , y} + 32 ) ≫ 6 ) ≪ 6 ) + ( 64 - wT - wL ) \times pred ( x , y ) + 32 ) ≫ 6$$

In another embodiment, when one or more proposed mechanisms are used, one or more matrixes or intra prediction modes are used to generate the final predictors for the current block. A representative prediction mode is required for the following transform process or stored for the subsequent coding luma or chroma blocks. In the following, a general concept of transform process is introduced and several methods are proposed to find the representative prediction mode.

### General Concept of Transform Process

In a general transform process at the encoder, the residuals for the current block are processed (or transformed) by a primary transform mode and then become the first temporary transform coefficients; the temporary transform coefficients may further be processed by a secondary transform mode and then become the second temporary transform coefficients; and after the remaining operations of residual coding, the bitstream containing the information of transform coefficients is transmitted to decoder. In a general transform process at the decoder, the second temporary transform coefficients are obtained from the received bitstream; the second temporary transform coefficients may be processed (or inverse transformed) by the secondary transform mode and then get the first temporary transform coefficients; the first temporary transform coefficients are processed by the first transform mode, for example, the primary transform mode, and then get the residuals for the current block. In the above-mentioned example, up to two transform modes (e.g., the primary transform mode and the secondary transform mode) are used for the current block. Note that it is not limited to this case.

In one embodiment, more than two transform modes are used for the current block. That is, at the encoder, after the secondary transform process, more transform modes are applied; at the decoder, before the secondary transform process, more transform modes are applied.

In another embodiment, only one transform mode (e.g., primary transform mode) is used for the current block. For example, when NSPT is used as the primary transform, only the primary transform (i.e., no secondary transform) is used for the current block.

In another embodiment, whether to use an additional transform mode for the current block depends on a pre-defined rule. For example, the predefined rule is implicit. The implicit rule refers to block width, block height, block area, and/or neighbouring coding information. For another example, the pre-defined rule is explicit. The explicit rule depends on a block, SPS, PPS, tile, slice, picture, and/or sequence-level flag. In one case, the explicit flag indicates the maximum number of the transform modes for the current block. If the maximum number of the transform modes is 2, the primary transform mode and the secondary transform mode are used for the current block. In another case, the explicit flag indicates whether to use one more transform mode for the current block. For another example, the rule depends on the block properties such as the number of the significant coefficients, the position of the significant coefficients, and/or the distribution of the significant coefficients. The rule can use the syntax related to the position of the last significant coefficient, the syntax related to whether a coding group within the current block contains any significant coefficient, and/or the position of a coding group in the current block.

In another embodiment, the proposed mechanism is to support more transform candidates for a target transform mode. The target transform mode refers to the primary transform mode, secondary transform mode, and/or any of the transform modes (e.g., any of the more than two transform modes).

In another embodiment, if a transform mode refers to a separable transform mode, the transform mode includes a transform type (e.g., matrix or kernel) for the horizontal transform and a transform type for the vertical transform; otherwise (the transform mode refers to a non-separable transform mode), a joint transform type is used. For example, the primary transform mode is a separable transform mode. For example, the primary transform mode is a non-separable transform mode. For example, the secondary transform mode is a separate transform mode. For example, the secondary transform is a non-separable transform mode. An example of the separable transform mode is to set {horizontal transform, vertical transform} as {DCT-II, DCT-II}, {any transform type of MTS (Multiple Transform Selection), any transform type of MTS}, {DCT-II, any transform type of MTS}, {any transform type of MTS, DCT-II}. An example of non-separable transform is LFNST or NSPT (non-separable primary transform). For an example of NSPT (a primary transform mode with similar concept as LFNST, but different matrixes from LFNST), 35 transform sets are used for each NSPT type (i.e., NPST4×4, NPST4×8, NPST8×4, and NPST8×8) and the transform set is determined by intra mode. Each NSPT transform set includes three transform kernels and is specified by the explicitly signalled

NSPT index. For the example of using DCT-II or MTS as the primary transform and LFNST as the secondary transform (when MTS is used, secondary transform cannot be used), NSPT is used to replace DCT-II+LFNST for the block sizes 4×4, 4×8, 8×4 and 8×8. Consequently, LFNST4 and LFNST8 will not be tested for these block sizes. However, they are still used for larger block sizes. NSPT here can be extended or modified as to utilize extra non-separable transforms for 4×4, 4×8, 4×16, 8×4, 8×8, 8×16, 16×4, 16×8 and 16×16 intra blocks, and/or besides the existing DCT-II+LFNST and adaptive MTS, to apply additional non-separable transforms, and/or for each block size, to derive 67 transform kernels based on different intra prediction modes, and/or to signal an additional flag (after the existing MTS flag) to indicate whether the non-separable primary transform is applied. If the flag is true, the MTS index is not signalled and use NSPT instead. Otherwise, the MTS index is further signalled.

In another embodiment, zero-out operations may be used in a transform mode. Whether to parse the signalling of the transform mode at the decoder will check if any significant coefficient is located at the zero-out region. The checking may use the syntax related to the position of the last significant coefficient, the significant flag of a coding group (indicating whether a coding group contains any significant coefficient), and/or the position of a coding group in the current block. If yes, the signalling of the transform mode is bypassed or always indicates disabled (may need bitstream conformance definition); otherwise, the signalling of the transform mode may be parsed at the decoder.

In another embodiment, the current block is coded by intra, inter, or IBC. For example, the prediction type for the current block is MODE_INTRA, MODE_INTER, or MODE_IBC. For the example of the current block coded by intra, at the encoder, the residuals are generated according to prediction based on the spatial neighbouring reference samples and the intra prediction mode; at the decoder, the residuals and the mentioned prediction are used to reconstruct the current block. For the example of the current block coded by inter, at the encoder, the residuals are generated according to prediction based on the reference samples in previous coded pictures and the inter motion information; at the decoder, the residual and the mentioned prediction are used to reconstruct the current block. For the example of the current block coded by IBC, at the encoder, the residuals are generated according to prediction based on the reference samples in the same picture and the block vector information; at the decoder, the residual and the mentioned prediction are used to reconstruct the current block.

### Representative Prediction Mode in Transform

Determining the representative prediction mode for regular intra mode, special intra mode, non-intra mode and/or any mode, for example, any mode in Note A, is proposed.
The regular intra mode means that one or more traditional intra prediction modes and spatially neighbouring reference samples (located in the adjacent or non-adjacent reference line for the current block) are used to generate the predictors for the current block. The regular intra mode may be used for luma and/or chroma components and the used traditional intra prediction modes may be indicated with syntax elements and/or a pre-defined implicit derivation method (such as DIMD which applies histogram analysis to suggest one or more intra prediction modes and/or TIMD which applies template analysis to suggest one or more intra prediction modes).
The special intra mode means that when the current block is coded with the special intra mode, instead of using a traditional intra prediction mode (e.g. one of 67 intra prediction modes) to generate the predictors for the current block, an alternative scheme (such as a matrix-based scheme and/or cross-component information) is applied to the spatially neighbouring reference samples and/or the reference samples from the collocated luma block to generate the predictors for the current block. For example, the special intra mode refers to Matrix-based Intra Prediction (MIP) or any intra mode using a derived or pre-defined matrix and input reference samples to generate prediction of the current block. The special intra mode may be used for luma and/or chroma components. For example, the special intra mode for chroma refers to any one of cross-component modes which mean the current chroma block references predicted/reconstructed samples or any pre-defined information of the one or more collocated luma blocks to generate the prediction for the current chroma block. An example of the cross-component modes are LM modes (such as CCLM and/or MMLM) and/or any one of LM variations (such as CCCM and/or GLM). For example, the special intra mode refers to CCLM, MMLM, CCCM, GLM, any LM variation, or fusion of chroma intra prediction modes. For example, the special intra mode refers to TMP.
The non-intra mode means IBC, inter mode, and/or any mode with mode type not equal to intra mode type (MODE_TYPE_INTRA). The non-intra mode may be used for luma and/or chroma components.
The modes in Note A are shown in the following.
   SGPM
   HOR/VER PL (for example, the design in JVET-AA0104 or other variation)
      For horizontal planar mode, only the horizontal linear interpolation is performed based on the left reference sample and the top-right reference sample to predict the current sample as:

$$pred ( x , y ) = ( ( W - 1 - x ) * rec ( - 1 , y ) + ( x + 1 ) * rec ( W , - 1 ) + ( W ≫ 1 ) ) ≫ {log}_{2} W$$

For vertical planar mode, only the vertical linear interpolation is performed based on the above reference sample and the bottom-left reference sample to predict the current sample as:

$$pred ( x , y ) = ( ( H - 1 - y ) * rec ( x , - 1 ) + ( y + 1 ) * rec ( - 1 , H ) + ( H ≫ 1 ) ) ≫ {log}_{2} H$$

When HOR/VER PL is used for the current block, other variation, for example, decoder side derivation method, is to decide which of the two directional planar modes is used. Specifically, the horizontal gradient for each sample in the adjacent row of the current block and the vertical gradient for each sample in the adjacent column of the current block are calculated. If the sum of the absolute values of the horizontal gradients is greater than the sum of the absolute values of the vertical gradients, the vertical planar mode (or horizontal planar mode) is used, otherwise, the horizontal planar mode (or vertical planar mode) is used.
Instead of directly using planar mode for the transform/inverse transform stage and/or the subsequent coding blocks, (1) the horizontal planar mode and vertical planar mode are modified into vertical (or horizontal) mode and horizontal (or vertical) mode respectively or (2) any proposed methods in this invention are used. In another embodiment, the selection between (1) and (2) depends on block width/height/area. For example, if the block width/height/area is smaller than a predefined threshold (such as 2, 4, . . . or any pre-defined value), (1) is used; otherwise, (2) is used.
DBV (Direct Block Vector): a chroma prediction mode
   Variation 1:
      A bin is signalled to indicate whether to use DBV mode or not
      When chroma dual tree is activated in intra slice, for a chroma CU coded as DBV mode, if one of the collocated luma blocks is coded with IBC mode or IntraTMP mode, its block vector bvL is used to derive chroma block vector bvC. The bv (block vector) scaling process is determined according to template matching. If the luma block is coded with a RRIBC (Reconstruction-Reordered IBC), a flip-aware bv adjustment is conducted for bvL, same as JVET-AA0070.
      By using the position of the current chroma block (xCb, yCb) and its bvC, the corresponding offset position (xCb+bvC[0], yCb+bvC[1]) is determined, and a block copy prediction is performed.
   Variation 2:
      When chroma dual tree is activated in intra slice, for a chroma CU coded as DM mode, if a pre-defined collocated luma block is coded with IBC mode or IntraTMP mode, its block vector bvL is used to derive chroma block vector bvC. The bv scaling process is determined according to template matching. If the luma block is coded with a RRIBC, a flip-aware bv adjustment is conducted for bvL, same as JVET-AA0070.
      By using the position of the current chroma block (xCb, yCb) and its bvC, the corresponding offset position (xCb+bvC[0], yCb+bvC[1]) is determined, and a block copy prediction is performed.
   Instead of using planar mode for the transform/inverse transform stage and/or the subsequent coding blocks, (1) chroma DM is used or (2) any proposed methods in this invention are used. In another embodiment, the selection between (1) and (2) depends on block width/height/area. For example, if the block width/height/area is smaller than a predefined threshold (such as 2, 4, . . . or any pre-defined value), (1) is used; otherwise, (2) is used.
Mixed modes (e.g. CIIP/GPM)

At the prediction stage, to improve prediction efficiency, different modes may apply adjustment when generating predictors or after generating predictors. For the regular intra mode, the final predictors may be the combined predictors based on the multiple hypotheses of predictors from each of the more than one traditional intra prediction modes. Therefore, it is hard to directly find a representative prediction mode among the more than one traditional intra prediction modes. For the special intra mode and/or the non-intra mode, the predictors are not generated based on a (traditional) intra prediction mode. However, in some cases, the intra prediction mode for the current block will be required.
In the following encoding/decoding stages after/before/parallel to prediction process, it will use the intra prediction mode for the current block.
   In the transform/inverse transform stage, the intra prediction mode is used by secondary transform, where the transform mode can be any mentioned transform mode in Section “General Concept of Transform Process”. For example, the case may correspond to selecting the transform set and/or the transpose flag for secondary transform (e.g. LFNST). The secondary transform in this invention is not limited to LFNST and can be any pre-defined separable/non-separable and/or low-frequency/non-low-frequency transform, which is performed after (or before) primary transform at the encoder (or decoder) and is applied to the primary-transformed (or received-dequantized) coefficients at the encoder (or decoder).
   In the transform/inverse transform stage, the intra prediction mode can be used by primary transform, where the transform mode can be any mentioned transform mode in Section “General Concept of Transform Process”. For example, the case may correspond to selecting the transform kernel for the primary transform (e.g. a default primary transform such as DCT-II and/or MTS and/or NSPT). The primary transform in this invention can be any pre-defined transform, which is performed on residuals (or inverse-secondary-transformed coefficients or received-dequantized transformed coefficients) at the encoder (or decoder).
   In the transform/inverse transform stage, the intra prediction mode can be used by any transform mode (i.e., may be referred by the primary transform, secondary transform, or any of the more than two transform modes) mentioned in Section “General Concept of Transform Process”.
For the subsequent coding blocks, the intra prediction mode information from one or more neighbouring or previous coded blocks is used for deriving the MPM list or any scheme which may reference the intra prediction mode information from one or more neighbouring or previous coded blocks.
If the current block is a luma block, the collocated chroma block may need the intra prediction mode from luma (e.g. to decide the chroma DM).

Therefore, when one of the above-mentioned modes is applied to the current block, the proposed novel mechanism can be used to determine a representative prediction mode for using in the one or more above-motioned cases.

In one embodiment, the representative prediction mode is any one of DIMD derived modes (e.g., applying histogram analysis on the spatially neighbouring reconstructed samples adjacent or non-adjacent to the current block), TIMD derived mode (e.g., applying template analysis on the spatially neighbouring reconstructed samples adjacent or non-adjacent to the current block), DC, planar, horizontal, vertical, diagonal, or any pre-defined mode from the available intra prediction modes. Take the current block coded by MIP (which can be changed with any regular intra mode, special intra mode, non-intra mode, and/or any mode in Note A, and the pre-defined intra prediction mode being DIMD derived mode as an example.

The DIMD derived mode is stored for MIP and/or can be used for any one or more in the following:
the subsequent blocks to derive the MPM list or any scheme which may reference the intra prediction mode information from one or more neighbouring or previous coded blocks
the collocated chroma block to decide its intra prediction mode (e.g. to derive chroma DM) if the current block is luma
the current block to decide the transform set and/or the transpose flag and/or the transform kernel for the transform stage

An example of applying histogram analysis on the spatially neighbouring reconstructed samples is shown in FIG. 14A, where region 1420 corresponds to the neighbouring region used as the template for the current block 1410. The window 1422 is applied to each or any subset of the neighbouring region (template). The centre of the window is on each or any subset of the centre samples in the neighbouring region. The centre samples are shown as small circles 1424 filled with dots.

An example of applying template analysis on the spatially neighbouring reconstructed samples is shown in FIG. 14B. TIMD cost (based on the template) is calculated as the distortion between the reconstructed samples and predicted samples in the neighbouring region 1420 (i.e., the template) for the current block 1410, where the predicted samples in the neighbouring region (i.e., the template) are generated according to a candidate prediction mode.

In one sub-embodiment, when using the template in the above examples, the template may include a top template 1520, a left template 1530 and a top-left template 1540 as shown in FIG. 15A for a current block 1510, or any extension from the top template 1550, and/or any extension from the left template 1560, and/or only any subset of the above as shown in FIG. 15B. The size of the top template is pre-defined as block width×H1, the size of the left template is pre-defined as W1×block height, and the size of the top-left template is pre-defined as W1×H1 where W1 and/or H1 are 1, 2, 3, 4, . . . , or any pre-defined values. In one example, H1 and W1 are the same. In another example, H1 and W1 are different. In another example, H1 and/or W1 vary with the block size. If the block height is larger than a pre-defined threshold, H1 gets larger. If the block width is larger than a pre-defined threshold, W1 gets larger. Some extensions of the template are as follows. Width of the extended top template is increased to any pre-defined value larger than block width such as block width+block height or k*block width. Height of the extended left template is increased to any pre-defined value larger than block height such as block height+block width or k*block height.

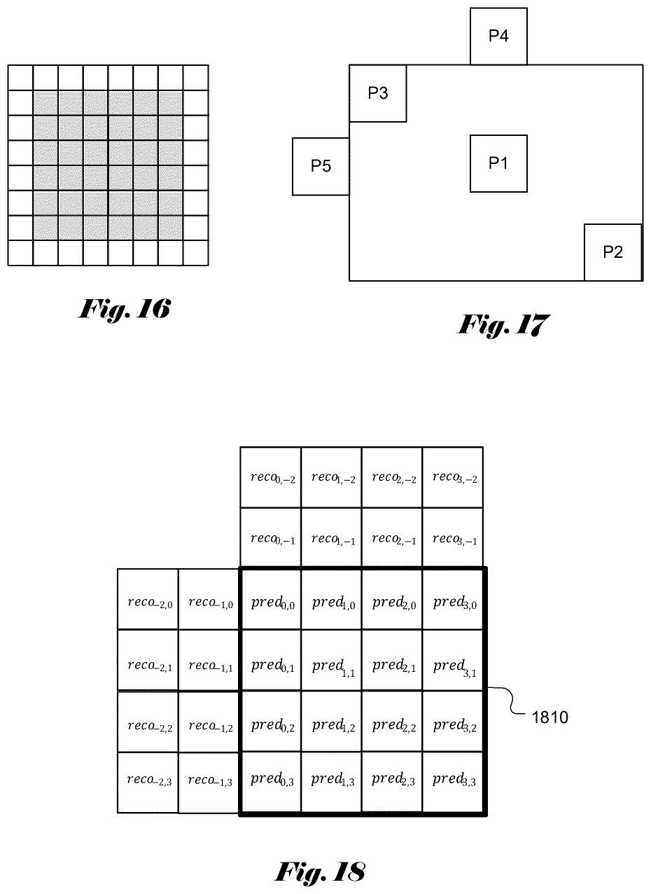

In another embodiment, the representative prediction mode is determined by applying a pre-defined process to all or any subset of the predicted samples of the current block. The pre-defined process will suggest an intra prediction mode as the representative prediction mode for the current block. In one sub-embodiment, the pre-defined process refers to DIMD and/or TIMD. In one sub-embodiment, when the current block is a chroma block and coded with cross-component mode or fusion of chroma intra prediction mode, the pre-defined process is applied to all or any subset of the reconstructed/predicted samples of the one or more collocated luma blocks. Take DIMD as an example, the window used in DIMD is applied to the predictors within the current block. In another sub-embodiment, the predicted samples for applying the pre-defined process refer to the down-sampled or reduced predicted samples and the pre-defined process is applied to all or any subset of the down-sampled or reduced predicted samples. For example, the original size of the current block is 2M×2N and the reduced or down-sampled size of the current block is M×N by down-sampling from 2M×2N. In another sub-embodiment, as shown in FIG. 16, the centre of window is applied on the samples (in grey area) within the current (or reduced) block but not located at the boundary of the current (or reduced) block. In another sub-embodiment, the centre of window is applied on each sample within the current (or reduced) block. If the window requires any sample outside of the current (or reduced) block, padding from the boundary is used instead of referencing the samples outside of the current (or reduced) block. Take TIMD as an example, the TIMD cost for a candidate prediction mode is calculated as the distortion between the final predicted samples (e.g. if the current block is coded by IBC, the final predictors are generated according to block vectors) and the predicted samples (from a candidate prediction mode) for all or any subset of the current (or reduced) block.

Take the current block coded by MIP (which can be changed with any regular intra mode, special intra mode, non-intra mode, and/or any mode in Note A, and the representative prediction mode being from DIMD for the current block as an example. The representative prediction mode is stored for MIP and/or can be used for any one or more in the following
the subsequent blocks to derive the MPM list or any scheme which may reference the intra prediction mode information from one or more neighbouring or previous coded blocks
(If the current block is luma) the collocated chroma block to decide its intra prediction mode (e.g. to derive chroma DM)
the current block to decide the transform kernel for the transform stage

In another embodiment, the representative prediction mode is pre-defined as a default mode. The default mode can be planar, DC, or any pre-defined intra prediction modes in the standard. In one sub-embodiment, the default mode is fixed as one intra prediction mode. In another sub-embodiment, the default mode is selected according to the coding mode of the current block. For example, the default mode of MIP is planar; the default mode of intra TMP is planar; the default mode of SGPM (spatial GPM which uses intra predictions for the two subblocks split from the GPM partition)/GPM/any GPM variation is the mode according to partitioning angle or any one mode in the IPM (Intra Prediction Mode) list; the default mode of chroma cross-component mode is chroma DM; the default mode of horizontal/vertical planar is horizontal/vertical; the default mode of DBV is chroma DM or DC or the mode same as the default mode of IBC; the default mode of CIIP (Combined Inter And Intra Prediction) is TIMD or planar or any intra prediction mode using in CIIP; and/or the default mode of IBC is DC or planar. For example, the default mode of SGPM is the mode according to partitioning angle; for example, there is a mapping table created to map from the partitioning angle to the default mode and/or the size of the mapping table depends on the number of the candidate partition angles. If the number of the candidate partition angles is 32, the size of the mapping table is 32. The following shows a possible mapping table for the default mode being in one of 67-domain intra prediction modes: {50, 0, 44, 41, 34, 27, 0, 0, 18, 0, 0, 9, 66, 59, 56, 0, 50, 0, 44, 41, 34, 27, 0, 0, 18, 0, 0, 9, 66, 59, 56, 0}.

The number in { } refers to the default mode. The angle equal to 0 (i.e., vertical partitioning direction) refers to the default mode 50 (i.e., vertical intra prediction mode). The default mode number is symmetric. The first half in the table is the same as the second half in the table. In another example, the angle equal to 0 (i.e., vertical partitioning direction) refers to the default mode 18 (i.e., horizontal intra prediction mode). The mapping table size can be reduced by grouping the N candidate angles into multiple (<N) groups and the group index is used to find a default mode from the mapping table. The size of the mapping table is the number of groups. For example, using angle symmetry (e.g. angle 0 and 16 are symmetry and both are belonging to vertical partition directions), the symmetric angles are put into the same group.

In another embodiment, when the representative prediction mode is any one of DIMD derived mode (applying histogram analysis to the spatially neighbouring reconstructed samples adjacent or non-adjacent to the current block), TIMD derived mode (applying template analysis to the spatially neighbouring reconstructed samples adjacent or non-adjacent to the current block), or any mode that gets the most preferable suggestion (e.g. smallest cost, largest histogram, . . . ) among all candidate modes or when the representative prediction mode is determined by applying a pre-defined process to all or any subset of the predicted samples on the current block, where the pre-defined process (such as DIMD, TIMD, and/or any pre-defined method) would suggest an intra prediction mode as the representative prediction mode for the current block, some embodiments are designed to determine whether the suggestion is trustable. If trustable, use the suggested mode as the representative prediction mode for the current block; otherwise, use the default way to decide the representative prediction mode for the current block.

In one sub-embodiment, when using DIMD to suggest the representative prediction mode, whether the suggestion is trustable depends on the distribution of histograms. For example, when the largest histogram is larger than (T*the second largest histogram), the suggestion is trustable, where T is pre-defined as any value, such as 1.25, 1.5, 2.0, larger than 1. In implementation, bit-shifting operation is used instead of multiplying a floating value (T). For example, (2.0*the second largest histogram) is implemented as (the second largest histogram <<1). For another example, (1.25*the second largest histogram) is implemented as (the second largest histogram+the second largest histogram>>2). For another example, (1.5*the second largest histogram) is implemented as (the second largest histogram+the second largest histogram>>1). In another implementation, a lookup table is used instead of multiplying a floating value (T). By using the look table, T is approximated.

In another sub-embodiment, when using TIMD to suggest the representative prediction mode, whether the suggestion is trustable depends on the distribution of TIMD costs. For example, when T2*the smallest cost is smaller than the second smallest cost (for example, applying the similar rules or threshold to histogram in DIMD), the suggestion is trustable where T2 is pre-defined as any value such as 1.25, 1.5, 2.0 or any value larger than 1. In implementation, bit-shifting operation is used instead of multiplying a floating value (T2). For example, (2.0*the smallest cost) is implemented as (the smallest cost<<1). For another example, (1.25*the smallest cost) is implemented as (the smallest cost+the smallest cost>>2). For another example, (1.5*the smallest cost) is implemented as (the smallest cost+the smallest cost>>1). In another implementation, a lookup table is used instead of multiplying a floating value (T2). By using the look table, T2 is approximated.

In another embodiment, when the representative prediction mode is any one of DIMD derived mode (i.e., applying histogram analysis on the spatially neighbouring reconstructed samples adjacent or non-adjacent to the current block), TIMD derived mode (i.e., applying template analysis on the spatially neighbouring reconstructed samples adjacent or non-adjacent to the current block), or any mode which gets the most preferable suggestion (e.g. smallest cost, largest histogram, . . . ) among all candidate modes or when the representative prediction mode is determined by applying a pre-defined process to all or any subset of the predicted samples to the current block, where the pre-defined process (e.g. DIMD, TIMD, and/or any pre-defined method) would suggest an intra prediction mode as the representative prediction mode for the current block, some embodiments are designed to generate a new transform matrix/set according to more than one (e.g. 2) existing transform matrixes/sets selected from more than one (e.g. 2) suggested representative modes and/or the new transform matrix/set is used for the current block. When using DIMD to suggest the representative intra prediction mode and histograms of candidate modes are not easy to be distinguished (e.g. the largest histogram is similar to the second largest histogram), more than one representative modes (e.g. 2) are introduced. When using TIMD to suggest the representative intra prediction mode and costs of candidate modes are not easy to be distinguished (e.g. the smallest cost is similar to the second smallest cost), more than one representative modes (e.g. 2) are introduced.

In one sub-embodiment, the new transform matrix/set is generated by mixing more than one existing transform matrixes/sets. An example of using two existing transform matrixes/sets to mix as the new transform matrix is shown in the following. First one existing transform matrix/set is selected according to one suggested mode and the other existing transform matrix/set is selected according to the other suggested mode. Then, a new matrix/set is generated by mixing all or any subset of the values of transform matrix coefficients in the two existing transform matrixes as the new transform matrix by weighted averaging or mixing all or any subset of the transform matrix members in the two existing transform sets into the new transform set. The weighing for averaging or the rule of selecting members may or may not depend on histograms/costs in the pre-defined process.

In another embodiment, one or more intra prediction modes are pre-defined as preferable modes. when the representative prediction mode is any one of DIMD derived mode (applying histogram analysis on the spatially neighbouring reconstructed samples adjacent or non-adjacent to the current block), TIMD derived mode (i.e., applying template analysis on the spatially neighbouring reconstructed samples adjacent or non-adjacent to the current block), or any mode which gets the most preferable suggestion (e.g. smallest cost, largest histogram, . . . ) among all candidate modes or when the representative prediction mode is determined by applying a pre-defined process to all or any subset of the predicted samples on the current block where the pre-defined process (e.g. DIMD, TIMD, and/or any pre-defined method) would suggest an intra prediction mode as the representative prediction mode for the current block, some embodiments are designed to give the preferable modes higher priorities and then compared with other non-preferable modes during the pre-defined process. For example, when using DIMD to suggest the representative prediction mode, the histogram of a preferable mode is adjusted by multiplying its histogram by T3, where T3=1.25, 1.5, 2.0, or any value larger than 1. In implementation, bit-shifting operation is used instead of multiplying a floating value (T3). For example, (2.0*the histogram) is implemented as (the histogram <<1). For another example, (1.25*the histogram) is implemented as (the histogram+the histogram >>2). For another example, (1.5*the histogram) is implemented as (the histogram+the histogram >>1). In another implementation, a lookup table is used instead of multiplying a floating value (T3). By using the look table, T3 is approximated. For another example, when using TIMD to suggest the representative prediction mode, the cost of a preferable mode is adjusted by multiplying its cost by T4, where T4=0.25, 0.5, or any value smaller than 1. In implementation, bit-shifting operation is used, instead of multiplying a floating value (T4) or dividing 1/T4. For example, (0.25*the cost) is implemented as (the cost>>2). For another example, (0.5*the cost) is implemented as (the cost>>1). In another implementation, a lookup table is used, instead of multiplying a floating value (T4) or dividing 1/T4. By using the look table, T4 is approximated.

In one sub-embodiment, different coding modes may have different preferable modes. For example, when the current block is coded with SGPM coding mode, the preferable modes are defined according to the partitioning angle for the current block. For another example, when the current block is coded with MIP coding mode, the preferable modes are defined as planar, DC, or any pre-defined intra prediction modes. For another example, when the current block is coded with IBC or inter coding mode, the preferable modes are defined as planar, DC, any intra prediction mode based on mode information for any pre-defined subset of the prediction units (or coding block or any-pre-defined region) in the reference region (including the corresponding reference block indicated by the block vector or the motion vector and/or the neighbouring template of the corresponding reference block), or any pre-defined intra prediction modes. For another example, when the current block is coded with the cross-component mode, the preferable modes are defined as chroma DM, planar, DC, or any pre-defined intra prediction modes. For another example, when the current block is coded with DBV (Direct Block Vector) coding mode, the preferable modes are defined as chroma DM, planar, DC, horizontal, vertical, any intra prediction mode based on mode information for any pre-defined subset of the prediction units (or coding block or any-pre-defined region) in the reference region (including the corresponding reference block indicated by the block vector and/or the neighbouring template of the corresponding reference block), or any pre-defined intra prediction modes. For another example, when the current block is coded with the coding mode horizontal planar mode, the preferable modes are defined as planar, DC, horizontal, vertical, or any pre-defined intra prediction modes. For another example, when the current block is coded with the coding mode vertical planar mode, the preferable modes are defined as planar, DC, horizontal, vertical, or any pre-defined intra prediction modes. For another example, when the current block is coded with the intra TMP coding mode, the preferable modes are defined as planar, DC, horizontal, vertical, any intra prediction mode based on mode information for any pre-defined subset of the prediction units (or coding block or any-pre-defined region) in the reference region (including the corresponding reference block indicated by the block vector and/or the neighbouring template of the corresponding reference block), or any pre-defined intra prediction modes. For another example, the preferable modes refer to the default modes.

In another sub-embodiment, when using DIMD to suggest the representative prediction mode, the preferable modes are the first N modes suggested by TIMD, where N=1, 2, . . . , or any positive integer.

In another sub-embodiment, when using TIMD to suggest the representative prediction mode, the preferable modes are the first N2 modes suggested by DIMD, where N2=1, 2, . . . , or any positive integer.

In an alternative way, using mode information of the reference region to derive a representative prediction mode for regular intra mode, special intra mode, non-intra mode, and/or any mode in Note A is proposed. Compared to performing texture analysis (DIMD or TIMD) on the predictors within the current block or the spatially neighbouring samples, the alternative proposed method is simpler and/or can output the derived representative intra prediction mode earlier without waiting for the reconstruction or prediction stage to know the required predicted or reconstructed samples. Some embodiments in the following focus on using IBC for the current block. Note that the proposed methods are not limited to applying to an IBC block and can be used for the current block coded by any other mode (e.g. intra TMP or inter block). When the current block is coded with intra TMP, the reference block is found by template matching. When the current block is coded with inter mode, the reference block can be in a reference picture or a pre-defined picture, which is indicated with motion information of the current block and/or is pre-defined in the previously coded picture different from the current picture. For example, for the motion information of the current block being bi-prediction, the reference picture indicated by the reference index for list-0 and/or the reference picture indicated by the reference index for list-1 is used. For another example, for the motion information for the current block being uni-prediction, the reference picture indicated by the reference index for either list-0 or list-1 is used. If more than one reference picture is used, an order is used to define which reference picture is used first. One possible order is that the reference picture closer to the current picture (i.e., smaller POC) is used first. Another possible order is that the reference picture from a pre-defined list (list-0 or list-1) is used first.

In one embodiment, the representative prediction mode is derived based on mode information for any pre-defined subset of the prediction units (or coding block or any-pre-defined region) in the reference region (including the corresponding reference block and/or the neighbouring template of the corresponding reference block). The mode information includes mode types, intra prediction modes, motion information, block width, block height, block area, block shape, block ratio, residual information, transform information, partitioning information, and/or any subset/extension of the above.

In one sub-embodiment, if to find a representative prediction mode from the predefined subset of the prediction units fails, a default prediction mode is used as the representative prediction mode for the current block. The default prediction mode can be any available intra prediction mode such as planar or normal DIMD mode, which is always derived at the decoder.

In another sub-embodiment of the current block being coded by IBC, a reference block is indicated by the block vector and one or more mode information (e.g. intra prediction mode) saved in the reference block is used to derive the representative prediction mode for the current block. If the reference block is any one of special intra mode, and/or non-intra mode, a default intra prediction mode is used as the representative prediction mode; otherwise, the intra prediction mode for the reference block is used as the representative prediction mode for the current block.

In another sub-embodiment of the current block being coded by IBC, one or more prediction units in the reference region (may including the reference block and/or one or more prediction units spatially adjacent/non-adjacent to the reference blocks) are pre-defined and a scanning order is applied to the pre-defined prediction units. An example of the scanning order is shown as follows:
Selecting the intra prediction mode among the prediction units P1 to P5 follows a pre-defined order: P1, P2, P3, (P4, P5), where locations of P1-P5 are shown in FIG. 17.
   P1 covers the middle position in the reference block.
   P2 covers the right-bottom position in the reference block.
   P3 covers the left-above position in the reference block.
   P4 covers a pre-defined position (e.g. middle position) above-outer neighbouring the reference block.
   P5 covers a pre-defined position (e.g. middle position) left-outer neighbouring the reference block.
If the height of the block is greater than the width, P5 is checked prior to P4.
Otherwise, P4 is checked before P5.

Following the scanning order, an intra prediction mode among the pre-defined prediction units can be used as the representative prediction mode. For example, the first mode which has the intra prediction mode is used as the representative prediction mode. For another example, an explicit index is signalled/parsed to indicate an intra prediction mode among the pre-defined prediction units as the representative prediction mode. When the prediction unit in the pre-defined prediction units is not a valid mode, the invalid prediction unit is skipped during scanning or a default prediction mode is set for the invalid prediction unit. For example, non-intra (e.g. IBC), intra TMP, inter, MIP, and/or any mode in Note A is not valid.

In another sub-embodiment of the current block being coded by IBC, one or more prediction units in the reference region (may including the reference block and/or one or more prediction units spatially adjacent/non-adjacent to the reference blocks) are pre-defined and a voting method is applied to the pre-defined prediction units. The voting method (e.g. majority method by counting) means to use the most popular prediction mode as the representative prediction mode for the current block. When the prediction unit in the pre-defined prediction units is not a valid mode, the invalid prediction unit is skipped for counting or a default prediction mode is set for the invalid prediction unit for counting. For example, non-intra (e.g. IBC), intra TMP, inter, MIP, and/or any mode in Note A is not valid.

In another embodiment, when the representative prediction mode (an intra prediction mode) is used to decide the transform kernel of MTS, the MTS can be implicit or explicit and the current block can be regular intra mode, special intra mode, or non-intra mode. The explicit MTS (such as Enhanced MTS for intra coding) means after selecting the MTS set for the current block, an MTS index is signalled to find one candidate (transform pair) from the MTS set. The implicit MTS means an implicit mapping rule (not depending on the syntax elements) is used to find the candidate. With the proposed methods, for explicit MTS, the selection of the MTS set depends on the representative prediction mode; for implicit MTS, the candidate is decided depending on the representative prediction mode (following a mapping rule). Tables 3-5 show examples of the mapping rule.

TABLE 3
Example 1 for mapping rule.

| | horizontal | vertical |
|---|---|---|
| Intra prediction mode | transform | transform |
| Planar | DST-VII | DST-VII |
| Ang. 31, 32, 34, 36, 37 | | |
| DC | DCT-II | DCT-II |
| Ang. 33, 35 | | |
| Ang. 2, 4, 6 . . . 28, 30 | DST-VII | DCT-II |
| Ang. 39, 41, 43 . . . 63, 65 | | |
| Ang. 3, 5, 7 . . . 27, 29 | DCT-II | DST-VII |
| Ang. 38, 40, 42 . . . 64, 66 | | |

TABLE 4
Example 2 for mapping rule.

| Intra prediction | horizontal | vertical |
|---|---|---|
| mode | transform | transform |
| Even | DCT-VIII | DCT-II |
| Odd | DCT-II | DST-VII |

TABLE 5
Example 3 for mapping rule.

| Intra prediction | horizontal | vertical |
|---|---|---|
| mode | transform | transform |
| Even | DCT-II | DCT-VIII |
| Odd | DST-VII | DCT-II |

In another embodiment, the proposed methods can be used for colour format 4:4:4. The following shows an example. MIP can be used for chroma when the colour format is 4:4:4. For a chroma MIP block, the representative prediction mode can be used for the primary transform and/or secondary transform to select the transform set and/or the transpose flag.

In another embodiment, the representative prediction mode is stored in the buffer for intra prediction mode when the current block is coded with a special intra mode and/or non-intra mode. In the subsequent process, if any process needs to access the buffer for intra prediction mode, the buffer for intra prediction mode is readily available.

In another embodiment, the representative prediction mode can implicitly vary with the block width, block height, block area or vary according to an explicit rule (e.g., syntax in the block, tile, slice, picture, SPS, or PPS level).

In another embodiment, any proposed methods or any combinations of the proposed methods can be applied to any intra modes such as WAIP (wide-angle intra prediction), intra angular modes, ISP, MIP, any intra mode specified in the VVC or HEVC or background, or more developing modes in Note A.

In another embodiment, to reduce the latency caused by the proposed methods of determining the representative prediction mode for the current block, some enabling conditions are designed for the proposed methods and the proposed methods are allowed only when the enabling conditions are satisfied.

In another sub-embodiment, the enabling conditions include a size setting related to block width, block height, or block area, or block shape. A size setting means that the size of the current block is checked first and the proposed methods cannot be applied if the size of the current block is not hardware friendly or not good for the DIMD to calculate histogram or for the TIMD to calculate the cost. For example, when the width or height for the current block is larger than a pre-defined threshold, the proposed method cannot be used. For another example, when the width or height of the current block is smaller than a pre-defined threshold, the proposed method cannot be used. For another example, if the area of the current block is larger than a pre-defined threshold, the proposed method cannot be used. For another example, if the area of the current block is smaller than a pre-defined threshold, the proposed method cannot be used. For another example, if the longer side of the current block is much larger than the shorter side of the current block, the proposed method cannot be used. The pre-defined threshold can be any integer such as 2, 4, 8, 16, . . . , or any pre-defined value. When the proposed methods cannot be used, the default way is used to decide the representative prediction mode.

The proposed methods in this invention can be enabled and/or disabled according to implicit rules (e.g., block width, height, or area) or according to explicit rules (e.g., syntax in the block, tile, slice, picture, SPS, or PPS level). For example, the proposed method can be applied when the block area is smaller/larger than a threshold.

The term “block” in this invention can refer to TU/TB, CU/CB, PU/PB, pre-defined region, or CTU/CTB.

Any combination of the proposed methods in this invention can be applied.

### Boundary-Matching Costs

A boundary matching cost for a candidate mode refers to the discontinuity measurement (including top boundary matching and/or left boundary matching) between the current prediction (the predicted samples within the current block), generated from the candidate mode, and the neighbouring reconstruction (the reconstructed samples within one or more neighbouring blocks). Top boundary matching means the comparison between the current top predicted samples and the neighbouring top reconstructed samples, and left boundary matching means the comparison between the current left predicted samples and the neighbouring left reconstructed samples. An example of discontinuity measurement (including top boundary matching and/or left boundary matching) between the current prediction (the predicted samples (pred_{i,j}, 0≤i, j≤3) within the current block 1810) is shown in FIG. 18.

In one embodiment, a pre-defined subset of the current prediction is used to calculate the boundary matching cost.

Any of the foregoing proposed methods can be implemented in encoders and/or decoders. For example, any of the proposed methods can be implemented in an inter and/or intra and/or IBC and/or prediction and/or transform module of an encoder, and/or an inter and/or intra and/or IBC and/or prediction and/or transform module of a decoder. Alternatively, any of the proposed methods can be implemented as a circuit coupled to the inter and/or intra and/or IBC and/or prediction and/or transform module of the encoder and/or the inter and/or intra and/or IBC and/or prediction and/or transform module of the decoder, so as to provide the information needed by the inter and/or intra and/or IBC and/or prediction and/or transform module.

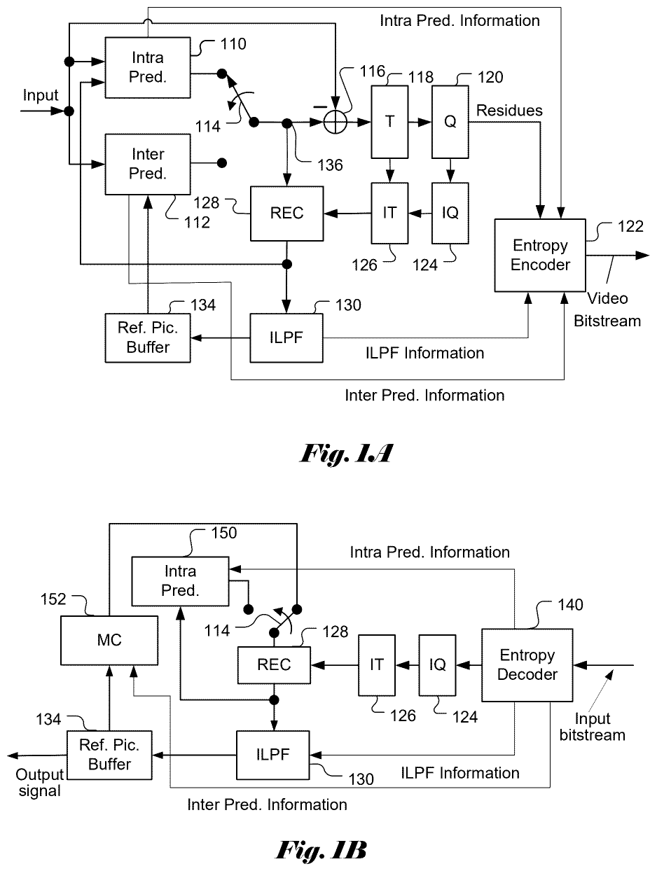

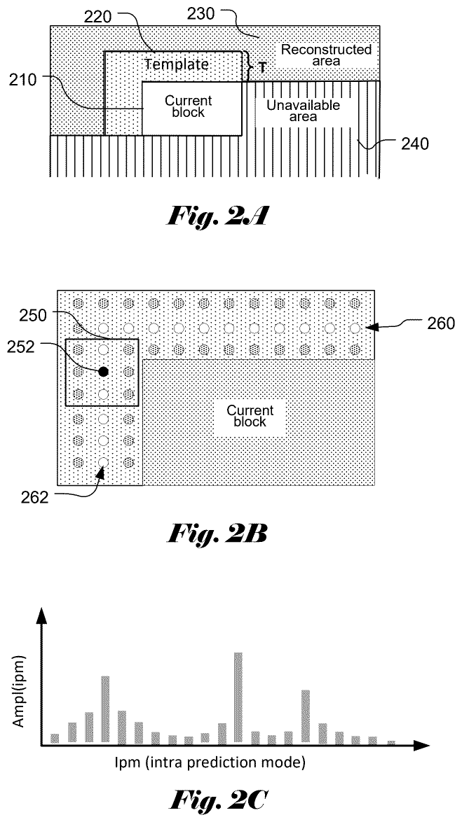

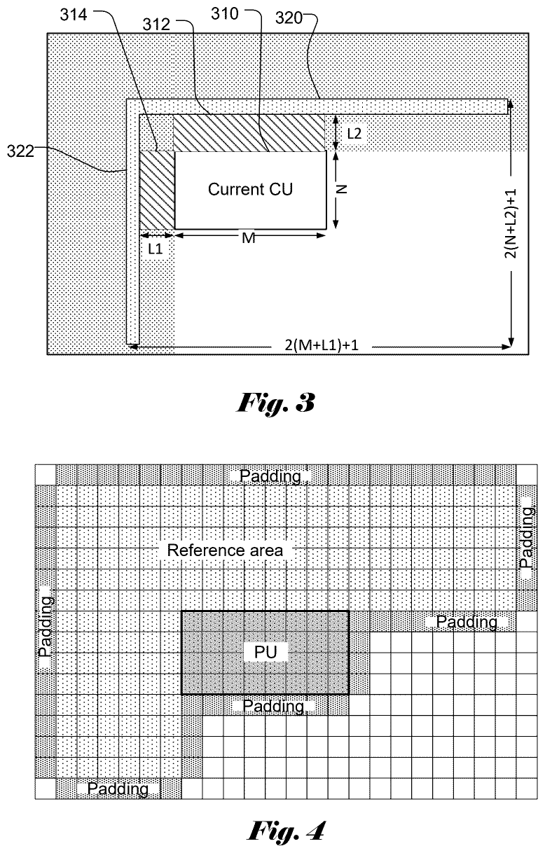

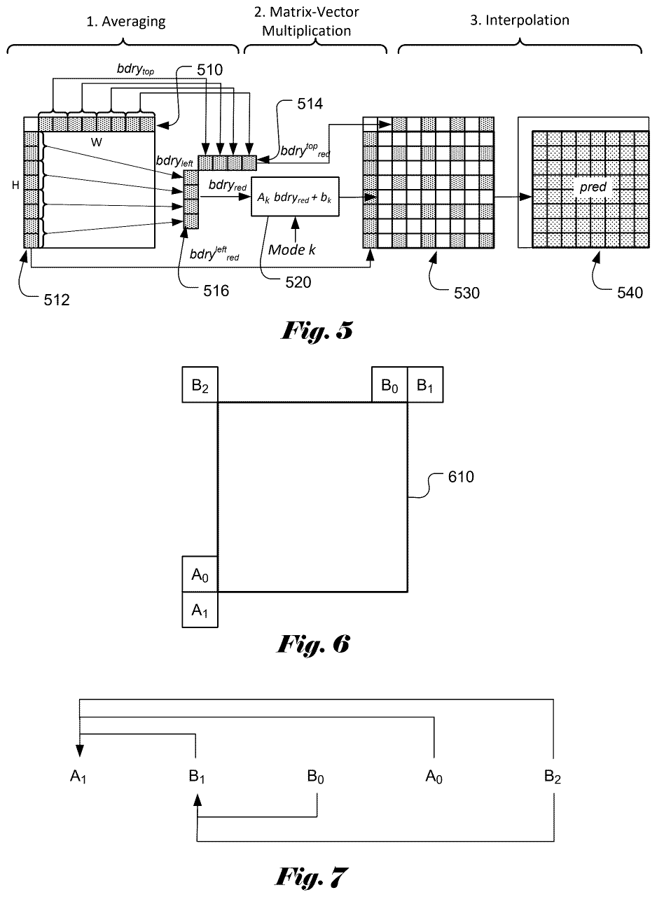

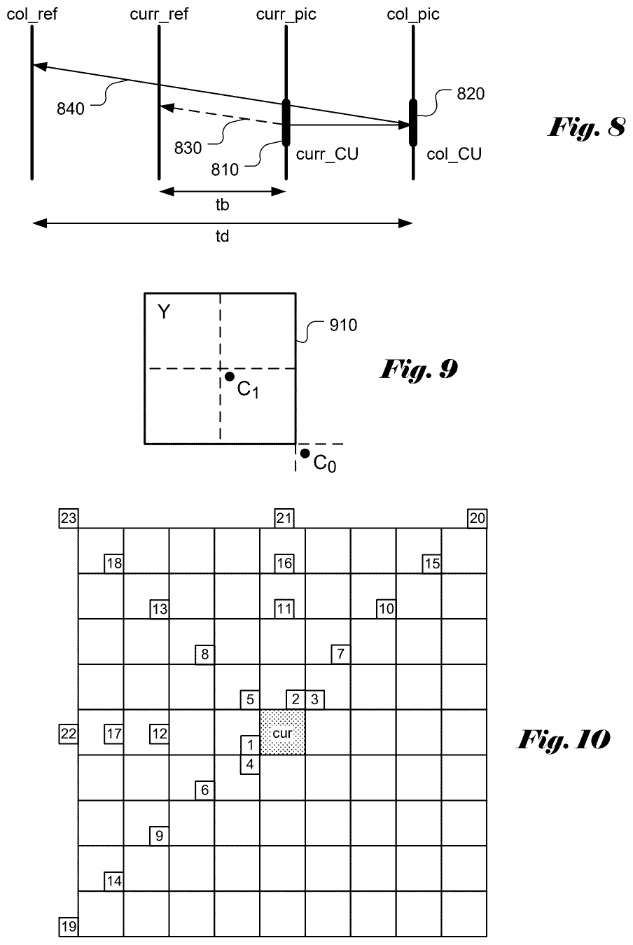

The MIP mode with one or more settings as described above can be implemented in an encoder side or a decoder side. For example, any of the MIP mode with one or more settings can be implemented in an Intra/Inter coding module (e.g., Intra Pred. 150/MC 152 in FIG. 1B) in a decoder or an Intra/Inter coding module is an encoder (e.g., Intra Pred. 110/Inter Pred. 112 in FIG. 1A). Any of the proposed MIP mode with various settings can also be implemented as a circuit coupled to the intra/inter coding module at the decoder or the encoder.

However, the decoder or encoder may also use additional processing unit to implement the required processing for the proposed MIP mode with one or more settings. While the Intra/Inter Pred. units (e.g., unit 110/112 in FIG. 1A and unit 150/152 in FIG. 1B) are shown as individual processing units, they may correspond to executable software or firmware codes stored on a media, such as hard disk or flash memory, for a CPU (Central Processing Unit) or programmable devices (e.g., DSP (Digital Signal Processor) or FPGA (Field Programmable Gate Array)).

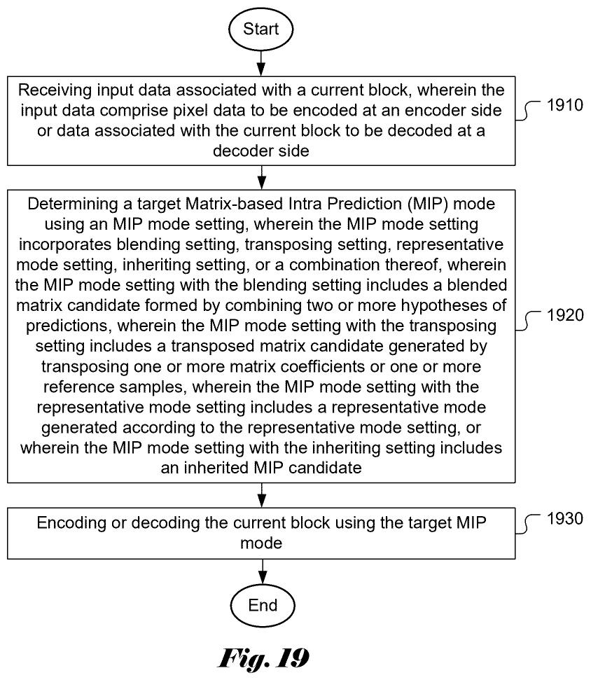

FIG. 19 illustrates a flowchart of an exemplary video coding system where the MIP mode uses one or more settings according to an embodiment of the present invention. The steps shown in the flowchart may be implemented as program codes executable on one or more processors (e.g., one or more CPUs) at the encoder side. The steps shown in the flowchart may also be implemented based hardware such as one or more electronic devices or processors arranged to perform the steps in the flowchart. According to the method, input data associated with a current block are received in step 1910, wherein the input data comprise pixel data to be encoded at an encoder side or data associated with the current block to be decoded at a decoder side. A target Matrix-based Intra Prediction (MIP) mode is determined using an MIP mode setting in step 1920, wherein the MIP mode setting incorporates blending setting, transposing setting, representative mode setting, inheriting setting, or a combination thereof, wherein the MIP mode setting with the blending setting includes a blended matrix candidate formed by combining two or more hypotheses of predictions, wherein the MIP mode setting with the transposing setting includes a transposed matrix candidate generated by transposing one or more matrix coefficients or one or more reference samples, wherein the MIP mode setting with the representative mode setting includes a representative mode generated according to the representative mode setting, or wherein the MIP mode setting with the inheriting setting includes an inherited MIP candidate. The current block is encoded or decoded using the target MIP mode in step 1930.

The flowchart shown is intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video coding, the method comprising:
receiving input data associated with a current block, wherein the input data comprise pixel data to be encoded at an encoder side or data associated with the current block to be decoded at a decoder side;
determining a target Matrix-based Intra Prediction (MIP) mode using an MIP mode setting, wherein the MIP mode setting incorporates blending setting, transposing setting, representative mode setting, inheriting setting, or a combination thereof, wherein the MIP mode setting with the blending setting includes a blended matrix candidate formed by combining two or more hypotheses of predictions, wherein the MIP mode setting with the transposing setting includes a transposed matrix candidate generated by transposing one or more matrix coefficients or one or more reference samples, wherein the MIP mode setting with the representative mode setting includes a representative mode generated according to the representative mode setting, or wherein the MIP mode setting with the inheriting setting includes an inherited MIP candidate; and
encoding or decoding the current block using the target MIP mode.

2. The method of claim 1, wherein the target MIP mode is used as an additional mode or a replacement mode.

3. The method of claim 1, wherein when the blending setting is used, said one or more hypotheses of predictions are generated according to one or more pieces of matrix information.

4. The method of claim 3, wherein combining weighting for the blended matrix candidate is block-based weighting.

5. The method of claim 3, wherein combining weighting for the blended matrix candidate is sample-based or position-based weighting.

6. The method of claim 3, wherein said one or more pieces of matrix information are obtained by using a suggestion scheme to select from a set of candidate matrix information, and wherein the set of candidate matrix information includes all or any subset of inheriting matrix information.

7. The method of claim 1, wherein said one or more matrix coefficients or said one or more reference samples are transposed as one or more additional candidate matrixes for the current block.

8. The method of claim 1, wherein the representative mode is generated according to DIMD (Decoder-side Intra Mode Derivation) or TIMD (Template-based Intra Mode Derivation).

9. The method of claim 1, wherein the representative mode is generated according to block width, block height, block area or a combination thereof.

10. The method of claim 1, wherein the representative mode is used to select a transform set of separable or non-separable primary or secondary transforms for the current block.

11. The method of claim 1, wherein the representative mode is used by one or more subsequent blocks after the current block.

12. The method of claim 1, wherein the representative mode is used as chroma DM (Direct Mode) of a subsequent chroma block.

13. The method of claim 1, wherein the representative mode is used as MPM (Most Probable Mode) of one or more subsequent intra or inter blocks.

14. The method of claim 1, wherein when the inheriting setting is used, matrix information is recorded.

15. The method of claim 14, wherein the matrix information comprises matrix size, matrix mode index, transposing information, target information for the target MIP mode to determine one or more predictors, or a combination thereof.

16. The method of claim 14, wherein an inheriting list is built for the current block.

17. The method of claim 16, wherein an inheriting index is signalled, parsed, or inferred to indicate target matrix information from the inheriting list.

18. The method of claim 17, wherein the target matrix information indicated by the inheriting index is used for the current block to generate a target MIP predictor.

19. The method of claim 18, wherein if one or more matrix sizes of the target matrix information are not belonging to a block size category of the current block, down-sampling or up-sampling setting is applied.

20. An apparatus of video coding, the apparatus comprising one or more electronics or processors arranged to:
receive input data associated with a current block, wherein the input data comprise pixel data to be encoded at an encoder side or data associated with the current block to be decoded at a decoder side;
determine a target Matrix-based Intra Prediction (MIP) mode using an MIP mode setting, wherein the MIP mode setting incorporates blending setting, transposing setting, representative mode setting, inheriting setting, or a combination thereof, wherein the MIP mode setting with the blending setting includes a blended matrix candidate formed by combining two or more hypotheses of predictions, wherein the MIP mode setting with the transposing setting includes a transposed matrix candidate generated by transposing one or more matrix coefficients or one or more reference samples, wherein the MIP mode setting with the representative mode setting includes a representative mode generated according to the representative mode setting, or wherein the MIP mode setting with the inheriting setting includes an inherited MIP candidate; and
encode or decode the current block using the target MIP mode.
